(19) United States
(12) Patent Application Publication
(10) Pub. No.: US 2023/0023545 A1
(43) Pub. Date: Jan. 26, 2023

(54) METHODS AND SYSTEMS FOR DEEP LEARNING CHIP DESIGN GENERATION

(71) Applicant: Michael Bass, Las Vegas, NV (US)

(72) Inventor: Michael Bass, Las Vegas, NV (US)

(21) Appl. No.: 17/735,070

(22) Filed: May 2, 2022

Related U.S. Application Data
(60) Provisional application No. 63/182,660, filed on Apr. 30, 2021.

(51) Int. Cl. G06N 3/063

(52) U.S. Cl. CPC G06N 3/063

(57) ABSTRACT

System and method for generating a chip design capable of implementing a variety of neural networks, including convolutional neural networks. The chip design can incorporate deep learning and/or artificial intelligence models having a framework adaptable to use a wide variety of machine leaning, deep learning, and AI models, as well as other mathematical operations known at compile time. In one instance, the generated chip design is in the form of hardware description language (HDL) code where “hardware” refers to computer hardware that includes computer chips, digital logic, circuitry and printed circuit boards. Alternate embodiments generate other output forms such as a netlist, silicon layouts and/or any description of the logic. The disclosed design uses a user's CNN or NN, and a resource quantity as input.

### CROSS-REFERENCE TO RELATED APPLICATIONS

This application claims the priority benefit of U.S. Provisional Application No. 63/182,660, filed Apr. 30, 2021, the content of which is incorporated herein by reference.

The following discloses technology used to generate a chip design that implements a neural network (NN) and sometimes more specifically, a convolutional neural network (CNN). The technology generates a chip design for disclosed types of deep learning or artificial intelligence (AI) models; however, the same approach and underlying framework can be adapted for a wide variety of machine leaning, deep learning, and AI models, as well as other mathematical operations known at compile time. In one instance, the generated chip design is in the form of hardware description language (HDL) code. In this disclosure, “hardware” refers to computer hardware including, but not limited to, computer chips, digital logic, circuitry and printed circuit boards. However, alternate embodiments can generate other output forms such as a netlist, silicon layouts, or any description of the logic. The disclosed technology uses as input a user's CNN or NN and a resource quantity. The required resource quantity can be stated specifically or more generally, including but not limited to a specific target chip, target development board, targeted piece of hardware or device, and/or the number of multipliers and memory units and respective equivalents.

The disclosed technology generates a chip design for a CNN or NN that can potentially include a wide variety of features and incorporate multiple components including: (a) an accelerated HDL design environment that enables developers to create HDL designs faster and automate much of the design; (b) a buffering core that performs the convolution and NN operations while also being capable of simultaneously loading data for future processing to reduce computational delay; (c) processes to generate the chip design components including the buffering cores, as well as other modules that implement CNN and NN features, based upon the resources the user provides. According to the technology, a module is defined as a chip design component that can be replicated and instantiated within other components of the chip design. For some embodiments that utilize HDL, in Verilog modules refer to the use of the keyword “module” and in VHDL modules refer to the use of the keywords “entity” and “architecture.” Similarly, an instantiated module is defined as a module that has been included, or instantiated, in another module. Further, the chip designs, chip design components, chip design structure, chip design elements, and chip design formats can comprise one or more of the following: HDL code such as Verilog, VHDL, or other, netlists, circuit diagrams, synthesized designs, or silicon layouts. (d) processes to instantiate all generated components within a chip design, arrange the components in their essential order, and forms all needed connections such that the resulting chip design performs the needed CNN and NN operations and features. (e) processes to create a schedule of when operations shall take place within the generated chip design, when reads and writes to memory will occur, and how to configure the generated chip based on the current layers being processed. Some embodiments then translate the created schedule into a combination of a series of instructions generated chip design logic to implement the created schedule. And 6) An alternate method and generation of logic that implements the multiply portion of the multiply accumulate operations that are essential to processing CNNs and NNs.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 depicts example inputs and outputs to a Data Memory and the access pattern of the logic, according to some aspects of the disclosed technology.

FIG. 2 depicts example inputs and outputs to a Multiply-Accumulate (MAC) Memory and the access pattern of the logic, according to some aspects of the disclosed technology.

FIG. 3A is a block diagram illustrating an example Multiple Buffering Deep Learning Core architecture that contains MAC Memory related components, according to some aspects of the disclosed technology.

FIG. 3B is a block diagram illustrating an example Multiple Buffering Deep Learning Core architecture that does not contain MAC Memory related components, according to some aspects of the disclosed technology.

FIG. 4 is a block diagram illustrating an example architecture for the generated Deep Learning Chip, according to some aspects of the disclosed technology.

FIG. 5 depicts how the schedule generation divides layer input data into sections, according to some aspects of the disclosed technology.

FIG. 6 depicts how the schedule generation assigns sections of layer input data to Data Memories and Multiple Buffering Deep Learning Cores, according to some aspects of the disclosed technology.

### ACCELERATED HDL DESIGN ENVIRONMENT

An initial aspect of the disclosed technology is a design environment that greatly accelerates the development speed and simplifies designing logic components. This accelerated HDL design environment is referred to as the Accelerated Development Environment (ADE). ADE enables users to easily write software to generate chip design components that take into consideration the surrounding chip design structures and enables use of various components within the chip design and others that will be generated by ADE. As opposed to typical chip design process and languages, ADE enables developers to algorithmically create (as opposed to manually) chip designs. Furthermore, ADE is not a preprocessor limited to predefined functionality. Instead, ADE enables each user or group to define their own processes for generating chip design components at a more powerful level of software abstraction. In some embodiments, ADE processes HDL code: however, alternate embodiments can work with a variety of chip design formats. ADE works by parsing a set of HDL code, extracting the code's structure, locating any user defined attributes within the code and running user defined algorithms according to the located attribute.

The user defined attributes, henceforth referred to as “attributes,” tie elements in the chip design structure to algorithms that generate the chip design. The attributes can be any unique identifier. In some embodiments, the attributes can be any sequence of characters such that the sequence is made known to ADE. Within ADE, each attribute is defined as the sequence of characters to be identified, as well as the corresponding algorithm. In some embodiments, attributes are contained within HDL comments and surrounded by brackets. In Verilog, one HDL language, the disclosed embodiment denotes attributes as “//[ . . . ]”, and in VHDL, a different HDL language, the disclosed embodiment denotes attributes as “--[ . . . ]”, where the ellipses can be any characters that match an attribute loaded into ADE. The characters that ADE matches to identify an attribute are referred to as the attribute tag. Therefore, each attribute consists of an attribute tag and an attribute algorithm. However, the attributes can contain more or fewer elements, depending upon the implementation.

ADE uses as inputs a set of chip design elements and a set of attributes. In some embodiments, the set of chip design elements is a set of HDL files. First, ADE parses the chip design elements and extracts all modules, instantiated modules, signals, variables, inputs, outputs, parameters, constants, and others as well as attribute tags. In some embodiments in which the chip design components are HDL, a variable is defined with the keywords “reg” and “wire” in Verilog and “signal” in VHDL. Then for each attribute tag extracted, ADE locates and performs the corresponding attribute algorithm. Adding a dynamic algorithm to chip design provides a substantial benefit by making the hardware description significantly more dynamic and adaptive.

ADE provides several helper functions to enhance the usefulness of attributes. These helper functions perform the following tasks: Generate Module Input, Generate Module Output, Generate Parameter, Generate Design at Start of Module, Generate Design at End of Module, Generate Design After Attribute, Add Port to Instantiated Module Port List, Get Next Variable, Get Variable, Get Next Parameter, Get Parameter, Get Next Instantiated Module, Get Instantiated Module, Get Next Attribute, Get Input, Get Output, Get Port, Find Module, and Import. These enable a developer to easily generate code where needed and not attempt to manually locate where to place generated design components. Some embodiments generate HDL code, but an alternate embodiment generates a different form of chip design components in the same manner. Next, each of these functions are described as they are performed in some of the disclosed embodiments using HDL code. Since ADE extracts the structure of the existing HDL code, ADE knows the location of characters and strings that identify the start and stop of different sections or elements of the HDL code. In the following description of the helper functions, as well as the entirety of this disclosure, placement of generated chip design components, or specifically HDL code, can be in any location within a module or chip design structure provided the placement is permitted by typical chip design processing tools.

ADE Helper Functions

Generate Module Input: ADE takes the input port name and an optional input port width and inserts them into the HDL code as an input in the module's port list. If an optional port width is not provided, a default port width is used.

Generate Module Output: ADE takes the output port name and an optional output port width and inserts them into the HDL code as an output in the module's port list. If an optional port width is not provided, a default port width is used.

Generate Module Inout: ADE takes the inout port name and an optional inout port width and inserts them into the HDL code as an inout in the module's port list. If an optional port width is not provided, a default port width is used.

Generate Parameter: ADE takes the parameter name and an optional parameter width and adds the HDL code for the parameter using the “parameter” or “constant” keywords after the end of the port list. If an optional parameter width is not provided, a default parameter width is used.

Generate Design at Start of Module: ADE takes the design components and logic provided and generates and instantiates them near the beginning of the module's logic. ADE keep a marker such that all variables and generated parameters will be above the marker and all components and logic will be below the marker. The marker can be any text, comment or position such that ADE is able to keep track of its location.

Generate Design at End of Module: ADE locates or keeps track of the keyword that ends the module's definition and generates and instantiates the provided design components and logic right before the keyword.

Generate Design After Attribute: ADE takes the design components and provided logic and generates and instantiates them after the user's attribute in the HDL code.

Add Port to Instantiated Module Port List: ADE takes as input either a module name and/or an instantiated module name, a port name, and a connection name. ADE then locates the instantiated module using Get Instantiated Module. If the instantiated module cannot be found, ADE reports an error. If the instantiated module is found, ADE generates a port in the instantiated module. This is done by inserting the HDL code for the port before the character or sequence denoting the end of the instantiated module's port list. ADE makes the port name the provided port name. ADE makes the signal connected to the port the provided connection name. Alternate embodiments can place the port at other locations within the instantiated module's port list.

Get Next Variable: Starting at the user's attribute, ADE steps through the HDL code until it locates the next variable. It then returns the variable name and width. Alternate embodiments can return only the name or a unique identifier for the variable.

Get Variable: ADE searches the whole module in which the user's attribute occurs and looks for a variable matching the provided name. If found, it returns the variable name and width. Alternate embodiments return only the name or a unique identifier for the variable.

Get Next Parameter: Starting at the user's attribute, ADE steps through the HDL code until it locates the next parameter or constant. It then returns the parameter's or constant's name and width. Alternate embodiments can return only the name or a unique identifier for the parameter.

Get Parameter: ADE searches the whole module in which the user's attribute occurs and looks for a parameter or constant matching the name provided. If found, it returns the parameter's or constant's name and width. Alternate embodiments can return only the name or a unique identifier for the parameter.

Get Next Instantiated Module: Starting at the user's attribute, ADE steps through the HDL code until it locates the next instantiated module. It then returns the module's name and the instantiated module's name.

Get Instantiated Module: ADE searches the entire module in which the user's attribute occurs and looks for an instantiated module whose module name matches the name provided or whose instantiated module name matches the name provided. Additionally, the user can specify that it matches either the module name or the instantiated module name. If found, it returns the module's name and the instantiated module's name.

Get Next Attribute: Starting at the user's attribute, ADE steps through the HDL code until it locates the next attribute. The attribute will be an attribute designed for ADE, not an HDL construct. It then returns the attribute.

Get Input: ADE searches the module's port list for the module in which the user's attribute occurs and looks for an input matching the name provided. If found, it returns the input's name and input's width. Alternate embodiments can return only the name or a unique identifier for the variable.

Get Output: ADE searches the module's port list for the module in which the user's attribute occurs and looks for an output matching the name provided. If found, it returns the output's name and output's width. Alternate embodiments can return only the name or a unique identifier for the variable.

Get Port: ADE searches the module's port list for the module in which the user's attribute occurs and looks for either an input, an output, or an inout that matches the name provided. If found, it returns the input or output's name and input or output's width. Alternate embodiments can return only the name or a unique identifier for the port.

Find Module: ADE searches through the list of all modules, both generated by ADE and not generated by ADE, to find a module whose name matches the name provided. If a match is found, the module is returned.

Import: Specifies that the following signal, bus, register, or variable should be found and routed from a different module to the module in which the user's attribute occurs. The user supplies the name of the module in which it should be found. The user can also supply a hierarchy of modules if desired to remove ambiguity. Furthermore, the user can use ADE properties, disclosed below, to further describe which instantiated module the routed value should come from. The specified start and end of the route is added to a list to be auto-routed, which is also described below.

In the description of these functions, it is disclosed that values and names are searched for. This does not require that a search algorithm be used or that a search is executed each time. Different techniques can be used to locate what is being searched for. Some embodiments use a combination of search, indexing, and storing locations. Alternate embodiments can use any technique to locate what is being searched for.

Another enhancement of ADE are properties. Properties are an attribute that does not perform an algorithm, but instead informs ADE about certain aspects of a given HDL element. Properties are used when processing other attributes. For example, if Attribute 1 generates five instantiated modules, it can use properties to number them 1 through 5, and then Attribute 2 can process each instantiated module depending on its property numbering.

ADE also provides a convenient method for attribute algorithms to request the value of a given property, parameter, or calculated value. If the value has already been determined, it is supplied to the attribute algorithm. However, if the value has not yet been located or calculated, ADE will suspend processing of the attribute algorithm and will resume once the requested value has been set. For example, this is beneficial when generating components that depend on resource availability. The attributes being processed can depend on the number of memory units that will be available. The attribute processing can be paused until these values are determined and will then resume their algorithms. Furthermore, this enables developers to not be concerned about complex dependencies and which values ADE must encounter first. Instead, dependencies can be resolved dynamically while ADE is processing the developer's design.

Internally we have created several attributes as part of ADE to assist in the development of deep learning hardware designs.

Import Attribute

One of the most needed and impactful attributes of the technology is the Import attribute that implements auto-routing. One of the greatest challenges in hardware development is routing signals within the design. When the location of an instantiated module changes or a signal is needed from a different module, routing the signal can be cumbersome and time consuming. Furthermore, when developing chip designs algorithmically, it is unknown where a signal will be located due to the dynamic nature of generating components, auto-routing connections becomes needed. Import allows the developer to state what instantiated module a signal is from and can give as little information as the name of the module or the name of the instantiated module, and then Import's attribute algorithm routes the wire automatically from the source to the destination. The developer can also provide only the name of the source signal and ADE will search for and locate the source. In some embodiments, this is performed as follows. ADE generates a tree graph, referred to as tree, of the design with each node being an instantiated module. Due to the nature of chip designs, the tree has one top level node with no parent and no loops. Additionally, also due to the nature of chip designs, the connection from a source to a destination can either traverse 1) only down the tree or 2) can first go up the tree and then transition only once to going down the tree. The path cannot go first up, then later down, and then later up; nor can the path start down and then later go up. ADE traverses the tree to locate the starting node. From there, ADE performs a breadthwise search to find the destination node. An alternate embodiment could perform any of the many tree search algorithms to locate the destination node.

To route the signals, ADE must insert inputs and outputs into modules and instantiated modules. There are four potential cases depending on whether the transition is from a parent node to a child node, or vice versa, and whether the previous transition went from a parent node to a child node, or vice versa. We will refer to a transition from a parent node to a child node as a “down transition” and a transition from a child node to a parent node as an “up transition.” Additionally, we will refer to the pair of transitions as the “previous transition” followed by the “current transition.” Therefore, the total potential transitions are up up, up down, down up and down down. However, due to the nature of chip designs, a down up transition is not possible. Therefore, there are only three possible transitions. Further, the signal being routed from the source to the destination will be referred to as the signal.

For an up up transition ADE will add the signal as an output port to the current node's module and route the signal from the child node by adding the signal as an output to the instantiated module of the child node. For an up down transition, ADE will route the signal from the child node by adding the signal as an output to the instantiated module of the child node and add a definition of the signal to the current node's module. For a down down transition, ADE will add the signal as an input to the current node's module and will route the signal from the parent node to the child node by adding the signal as an input to the instantiated module of the child node within the parent node's module.

The first transition does not have a previous transition and is therefore only either an up or down transition. For an initial up transition, ADE will add an output port for the signal to the current node's module. For an initial down transition, ADE will take no action.

Lastly, regarding auto-routing, the Import attribute allows a user to declare specific one to one, one to many, many to one, only up, and only down relationships. One-to-one relationships are the typical routing scenario that does not require additional specifications. Using properties, a feature of ADE previously described, or other identifiers such as, but not limited to, naming conventions, the Import attribute can perform one-to-many and many-to-one relationships. ADE can locate property names, or other identifiers, within an Import attribute tag. For one-to-many relationships, the receiving module denotes the property, or other identifier, that corresponds to each receiving module in the Import attribute tag. For many-to-one relationships, the receiving module defines a separate signal for each routed signal and supplies the sending property, or other identifier, for each in each signal's Import attribute tag.

In addition to auto-routing, we have used attributes to instantiate various modules with values that are determined dynamically, simplified repetitive code such as setting register values, set parameter values that are calculated depending on statically unknown variables, tracking the previous values of variables over multiple clock cycles, and generating modules dependent upon the resource amount available.

### Artificial Intelligence to Chip Platform

Each of the disclosed components of the technology has been created to design artificial intelligence into a chip platform (AI-CP). The AI-CP accepts as an input an AI model, or algorithm, that has been trained for a specific task as well as a resource quantity that can be used in the generated chip design. Examples of AI models are CNNs and NNs. The output of the AI-CP is a chip design. The output can also include a list of resources that were not used for the generated design. In one embodiment, the AI-CP produces a set of HDL files; however, alternative embodiments can produce other forms of chip designs such as a netlist, silicon layout and the like. ADE is used to process and generate chip design components for many, or all parts of the AI-CP.

Additionally, some embodiments are not restricted to a particular type of data input, such as a format including HDMI, JPEG, MP4 and the like. The focus of this technology and the generated chip design assumes that the input and output interfaces are implemented outside of the generated chip design. Alternate embodiments can implement the interfaces within the generated chip design.

Finally, all connection, routing, generations, and instantiations performed by the AI-CP are done so using ADE. This enables the AI-CP to easily declare where signals should be routed from and let ADE do the connections. Additionally, it allows the AI-CP to easily generate the chip design components, add inputs and outputs where needed, and instantiate previously generated components for the design. Alternate embodiments can create some, or all of the connections, routing, generations, and instantiations without using ADE.

### Multiple Buffering Deep Learning Core

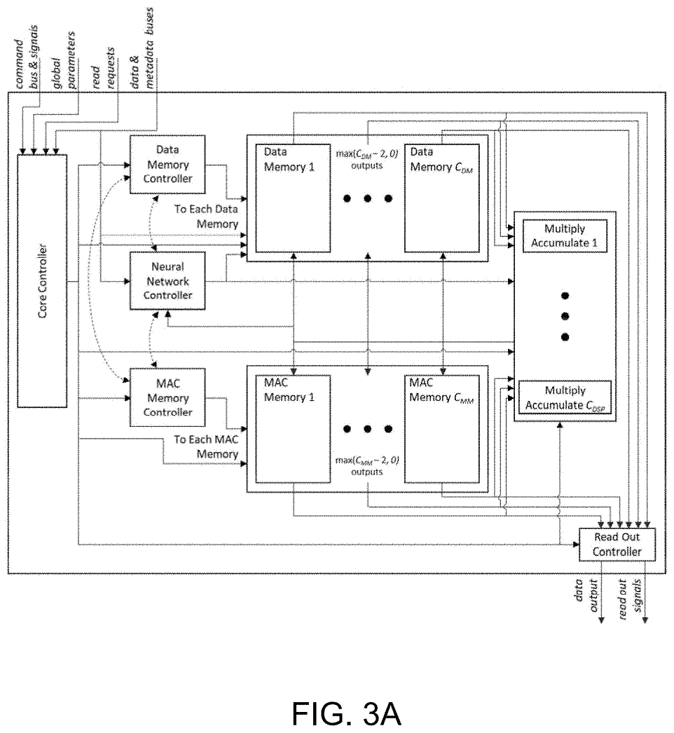

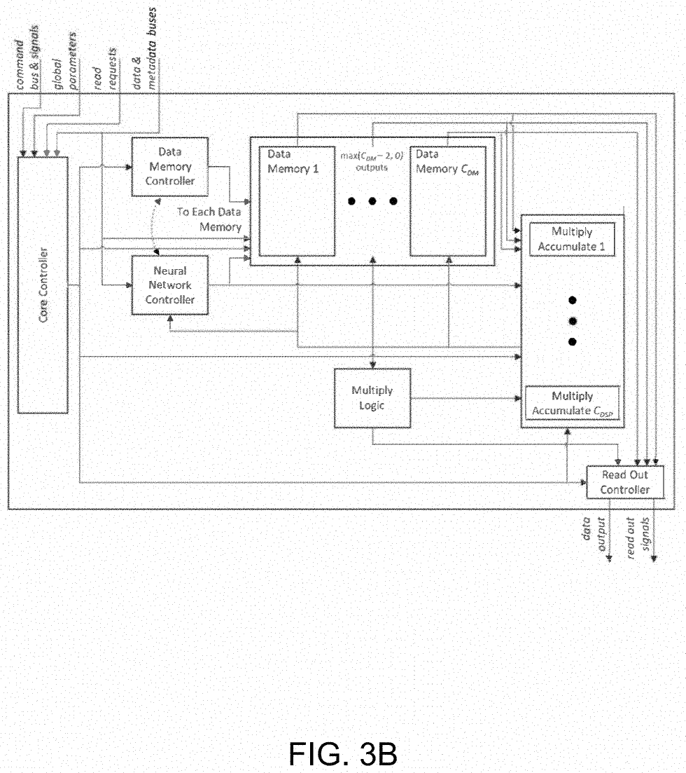

The second component of the technology is a small footprint processing core, referred to simply as a core that performs convolution and NN operations and uses multiple buffering, most of the time, for the input and output data. The core is generated using ADE based upon some or all of the following: a resource quantity, the chip's external memory read and write speeds and bandwidth, the input dimensions of deep learning layers, the output dimensions of deep learning layers and the dimensions of each filter. The AI-CP can generate cores with varying resources depending on the resources available and the user's AI model. The generated cores will include some, or all of the following: two types of components that contain memory units, data memories and exemplarily multiply accumulate (MAC) memories, a data memory controller, a MAC memory controller, MAC units, a NN controller, and a core controller as shown in FIG. 3A and FIG. 3B.

The first component of the core is the data memory that contains a memory unit and additional logic. The data memory stores input data to be processed during the deep learning operations. In addition to the memory unit that stores data, the data memory stores the data memory's assigned starting x-coordinate, assigned starting y-coordinate, assigned layer identifier, assigned filter size, and assigned section width and section height. The data memory also contains logic that determines when to store incoming data and how to read data out of the memory unit for the deep learning operations.

The second component of the core is the MAC memory, which also contains a memory unit and additional logic. The MAC memory stores the result of the convolution operations. In addition to the memory unit, the MAC memory contains logic to read intermediate and final results out of the MAC memory and store update calculations of the convolution operations being calculated. Alternatively, following the design of MAC Reduction as discussed below, the MAC memories store precomputed multiplication values for an assigned filter rather than the intermediate calculations.

One embodiment of the core uses one or more data memories and zero or more MAC memories. The number of each per core is determined by the AI-CP. The data memories are controlled by a data memory controller and the MAC memories are controlled by a MAC memory controller. Connected to each core are buses for commands, input data, and input metadata. The data memory controller parses commands and sets the starting x-coordinate, starting y-coordinate, layer identifier, and filter size for each data memory. In some embodiments, each data memory stores its own set of these values. However, an alternate embodiment could store the values in the data memory, share the values, or store them elsewhere. Additionally, some embodiments use separate data memory controllers and MAC memory controllers; however, an alternate embodiment can combine these or simply use logic elsewhere in the core or hardware description to control the memories. Some embodiments also store one or more layers of data in a data memory.

Once input data is available, the data memories begin storing the data if the data is contained in the data memory's assign section and layer. The core is a multiple buffering core because it will begin to store data for the next section to be processed while the current section's data is being processed. For example, assume there are three data memories with the first data memory storing data from the first section, the second data memory storing data from the second section, and the third data memory storing data from the third section. Once the first data memory has stored its input data, it notifies the data controller that it is ready to begin processing. The second and third data memories will begin storing their input data once it is available, which will most likely happen while the data in the first data memory is being processed. This enables there to be little overhead while reading in data and greatly increases throughput.

In addition to the memories and memory controllers, the core also contains one or more MAC units. A MAC unit multiplies two numbers together and adds the product to a third number. The AI-CP will determine how many MAC units will be in each core. The AI-CP will use ADE to connect the outputs of the data memories and MAC memories to the MAC units. The outputs of the MAC units are sent to the MAC memories. The typical dataflow is as follows. The convolution input layer data is read out from a data memory and intermediate summations are read out from the MAC memory. The data memory output is connected to one input of the multiplier in a MAC unit and the filter value being applied is connected to the other input of the multiplier in the MAC unit. The output from the MAC memory is then connected to the accumulate of the MAC unit. The output of the MAC unit is then stored in the MAC memory as an intermediate or final value. This is changed however when the core is processing a depth-wise convolution. Viewing the depth-wise convolution as two filters, the first which does not combine the output of multiple layers, and the second which does combine the output of multiple layers, a depth-wise convolution is implemented as follows. The first filter which does not combine the output of multiple layers is processed as usual, up to the point where the final results are stored in the MAC memory. However, the second filter is processed using the results of the first filter stored in the MAC memory. When applying the second filter, the data is read out of the MAC memory, as opposed to the data memory, and the MAC memory's output takes the place of the data memory's output as an input to the multiplier of the MAC unit. The accumulator is then set to 0. The output of this operation is then sent to the Data Output Combiner following the normal dataflow. Additionally, for depth-wise convolutions, logic is generated to perform the needed activation function for the data stored after convolving the first filter.

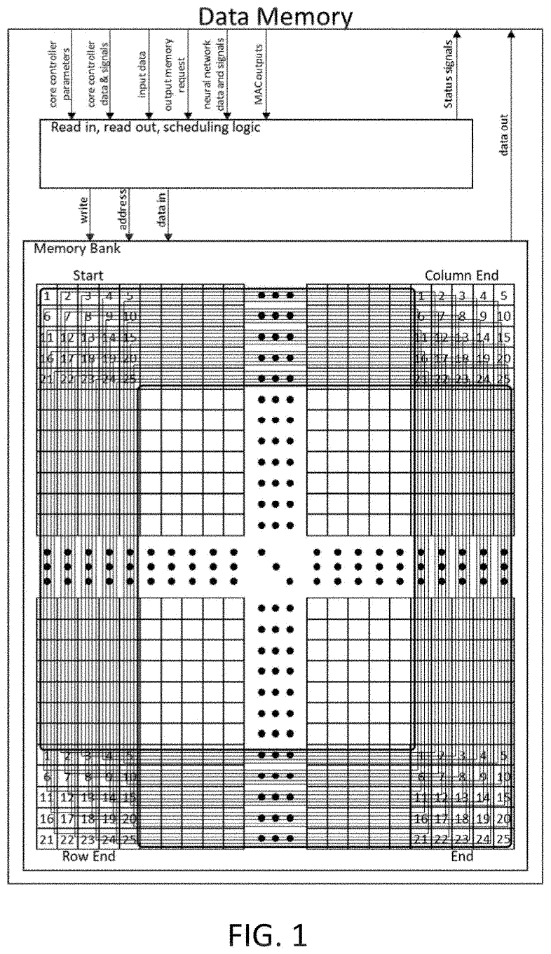

Once a data memory is ready to begin processing, it notifies the data memory controller. Once the AI-CP's created schedule (discussed in greater detail below) denotes that it is time for the core to begin performing operations, the data memory controller notifies the respective data memory to begin reading out data. Then, each data memory address is read out, multiplied by the respective filter value, added to any previous intermediate result, and stored in the MAC memory. Once the deep learning operation is complete, the MAC memory will be read out at the time denoted by the AI-CP's created schedule. The data memory read out logic is designed to read out the memory in the pattern that is needed for the convolution operations. The memory unit is a series of sequential addresses arranged as a one-dimensional structure. The data memory knows the assigned section width and section height. To account for the filter that is to be applied, the data memory stores a two-dimensional section of data with a width of section width (sw)+filter width (fw)−1 and a height of section height (sh)+filter height (fh)−1. Then, when performing a convolution, the data memory will first read out all values that will be used by the first filter value. After this, the data memory will read out all values that will be used by the second filter value. This will continue for each filter value. If the filter size is greater than 1×1, some of the data stored in the data memory will not be used by some of the filter values. Therefore, the data memory is read out as follows. The data memory begins with the first element and reads out sw sequential addresses. Then, the data memory will advance the address by fw. This will continue until the data memory has read out sh sequences of sw addresses. Once completed, the data memory will read out the data for the next filter location. To do this, the data memory must know the location to start the read out process. The data memory will advance the start address by one until it has done so fw−1 times. If the data memory has advanced the start address fw−1 times, then it will instead advance the start address by sw−fw+1. It will continue to advance the start address by one until it has done so another fw−1 times. The data memory will continue this process until completed fw*fh starts, each one reading out sw*sh addresses. This process is demonstrated for a 5×5 filter in FIG. 1. In this example the stride is set to one. The data memory accommodates different stride values by altering the amount the data memory increases the address in each step. Additionally, if the convolution layer in the layer group being process is an inception layer, the data memory adjusts its read out as follows. Theft) and fh used for all calculations is that of the largest filter in the convolution layer. Then, when the data memory is reading out its address for calculations, if the filter being applied is not the largest filter, the data memory ignores the ring(s) of addresses that apply to larger filters. For inception layers, alternate embodiments can process filters of the same size together without applying theft) and fh of the largest filter to all filters. Embodiments that store multiple input layers in a single data memory repeat the above process for each stored input layer.

Alternate embodiments can use varying read out patterns such as reading out an m×n section corresponding to a filter's position over the input or others as long as it produces data in a manner capable of performing convolutions. Additionally, some embodiments use distinct data memories and MAC memories; however, an alternate embodiment could easily use a combined data and MAC memory that can alternate its functionality or provide the functionality of each at the same time.

In contrast to the data memory, the MAC memory reads out and writes to addresses sequentially during convolution operations. Each time the data memory starts a new sw*sh read out, the MAC memory starts its read out at its first address and proceeds sequentially for sw*sh addresses. If no pooling layers are present in the current layer group (defined below), once the convolution operation is completed the MAC memory will read out its data sequentially. If pooling layers are present within the current layer group, the MAC memory will read out its data in a pattern such that it first reads out values that will be pooled together and then sequentially proceeds to the next set of values to be pooled together.

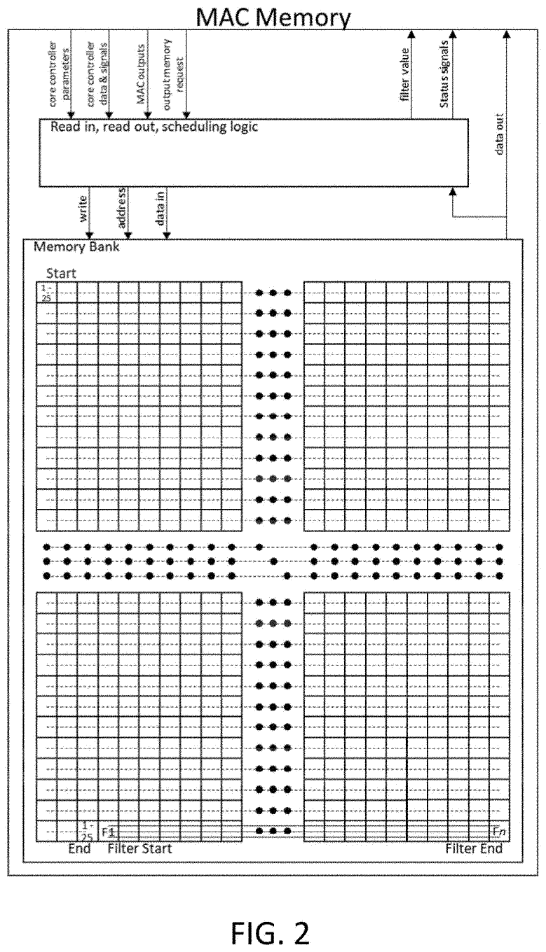

Additionally, the MAC memory stores the intermediate calculations also at its first address and proceeds sequentially for sw*sh addresses. Furthermore, the MAC memory stores the filter values in the last fw*fh addresses of the MAC memory. This is demonstrated in FIG. 2. Alternate embodiments can adjust the read out and write to structure of the MAC memory such that it is still able to compute convolution operations. Additionally, alternate embodiments can store the filter values in different locations such as registers, other memories, or even being sent to the core one at a time. Embodiments that store more than one input layer in a data memory perform the previous MAC memory steps for each stored input layer. Alternate embodiments can store multiple output layers in a MAC memory.

The data memory controller determines which data memory unit is currently being used for calculations and the order for future calculations. The MAC memory controller performs the same functions except for the MAC memories. Together, these controllers execute the AI-CP's created schedule that will be discussed later.

For many of the calculations reference is made to operations per unit of time (UoT). A UoT can be one clock cycle; however, depending on the architecture, the unit of time can be multiple clock cycles or even less than a clock cycle. Therefore, operations being done per UoT will refer to the minimum amount of time for a process or operation to take place.

In some embodiments, the NN controller coordinates which nodes have been assigned to the core and which nodes correspond to the current operations. Depending on the number of nodes assigned to the core and the number of digital signal processing (DSP) slices assigned to the core, the nodes to be processed are grouped into bins within the core. A DSP slice typically appears in a field-programmable gate array (FPGA) or as an intellectual property (IP) unit in an application-specific integrated circuit (ASIC). Some embodiments refer to a DSP slice for use of multiplication and accumulation, although not all additions within the generated chip will utilize a DSP slice. Alternate embodiments can use different approaches for multiplication and accumulation such as different types of chip design components or circuitry. For the balance of the disclosure, a DSP slice can be accounted for in alternate embodiments through alternative multiplication and/or accumulation chip design components. For example, alternate embodiments can replace a DSP slice with a multiplier, or they can replace a DSP slice with an adder, or they can replace a DSP slice with one or more multipliers and one or more adders, in addition to other possible components. If the core has been assigned 20 nodes to compute and the core has been assigned 4 DSP slices, then the core will have 5 bins. During each UoT the NN controller will select the next bin in a round robin fashion. The current bin is communicated to the data memory controller, or MAC memory controller, whichever is used to store the intermediate output node results. The respective memory controller will then read out the correct memory locations, gather the output from the MACs, and store the intermediate results in the correct memory locations. If there are enough MAC memory addresses to store the assigned intermediate results, then the MAC memories are used. This allows the data memories to store the incoming data for the next input's convolution operation. Otherwise, the data memories are used to store the intermediate results. An alternate method the core can use is to take advantage of the delay within a DSP slice to reduce the use of memory units. In this fashion the NN controller assigns multiple nodes to a DSP slice such that once the output is produced it is immediately fed into the DSP slice as the accumulate value. In this fashion, the NN controller does not use any memory unit and once the final output node value is ready, the NN controller forwards the value to the Read Out Chain. Other alternate embodiments can implement sparse NN layers. Sparse NN layers do not connect all input nodes to all output nodes. For sparse NN layers, alternate embodiments can use any of the previously stated techniques, as well as techniques that limit the calculation amount. Alternate embodiments can implement NN calculations outside of the core in a separate processing unit for NN operations. Such alternate embodiments can follow the previous steps or use alternative methods.

The read-out controller selects the appropriate output data to send out of the core to downstream components. The read-out controller selects between the instantiated data memory and MAC memory outputs depending upon which calculations are being performed and which calculations have been completed. The read out-controller is generated depending on the values of C_{DM} and C_{MM}.

The core controller stores necessary parameters and coordinates when to start and stop calculations. The word parameter does not strictly refer to the HDL keyword parameter. Some parameters store information about the current input data assigned to the core. Other parameters are precalculated values that are more efficient to precompute than to compute dynamically at runtime. Example parameters include the width and height of the current input layer, the number of layers in the input, the number of filters to process, the size of each filter, the assigned section width, the assigned section height, and the starting coordinates of the assigned section. The core controller also parses the command bus and command signals to update its parameters and initiate calculations.

### Non-Core Modules

While the cores perform the convolution and NN operations, other modules perform essential AI computations and manage operations, scheduling, and memory reading and writing. In the following discussion, the functionality of the non-core modules is described. First, modules that perform AI related operations or calculations are discussed. Following that, the modules that perform the needed scheduling and memory management are discussed.

Within some embodiments the convolution and NN operations are performed within the cores and the following AI calculations are performed within the Read Out Chain (ROC). Such operations within the ROC include combining the output of multiple convolution layers, applying the activation function, and operations such as pooling and batch normalization. The ROC operates in a pipelined fashion.

Data Output Combiner

The Data Output Combiner (DOC) receives the output from each core and combines the outputs if appropriate. In some embodiments, the DOC combines the core outputs during convolution operations but acts as a pass through for NN operations. Alternate embodiments can combine NN operations in the DOC. Some embodiments assign the same section x-start and y-start of the input to multiple cores, each assigned one or more different input layers. When the cores readout the output of their convolution operations the DOC sums the outputs together into a single output section. Some embodiments do this using a tree of adders such that the longest path through the adders is O(log(n)) where n is the number of additions to be performed. Alternate embodiments can perform the additions in a different pattern or combine the layer outputs in different locations within the chip. Once the DOC is finished combining the incoming data, or passing it through, the DOC sends values to the Activation Function.

While some filters are able to load each layer of the filter into the chip design at once, other filters have too many layers to load the entire filter into the chip at once. In the latter case, the DOC combines all present layers for the filter into a single layer and writes the result to memory. Once future layers of the filter are loaded and ready to be processed, the chip design loads the previously combined layer. The DOC then combines the newly processed filter layer outputs with the previously combined layer section output. Once all layers of the filter have been processed, all outputs of the filters will be combined into a single output layer section.

Some embodiments of the DOC use memory units to store and/or accumulate results. Some embodiments use memory units for all core outputs, while some embodiments use the memory units only for some core outputs. Additionally, some embodiments receive the multiplication result from DSPs within cores and perform functions similar to MAC memories.

Activation Functions

Different AI models use various activation functions and different layers within an AI model use different activation functions. Within the Activation Function (AF), logic determines the correct activation function based on the current layer being processed to apply to the received value and how to apply that activation function. Since the AI-CP uses ADE to generate the chip design, the AI-CP only generates and optimizes the activation functions needed for the particular AI model.

Not all data passed to the AF are ready for processing by the AF. Some of the combined values coming from the DOC require being combined with future processed layers before the values can be passed through an activation function. Once the AF has processed a value or passed it through, values are sent to the Following Layers Module.

Following Layers

After the activation function has been applied, values are processed through an assortment of potential layers. Within the convolution portion of a CNN, as opposed to the NN portion, in addition to the convolution layers, the CNN can contain batch normalization, pooling, skip, upsampling, and deconvolution, as well as many other features. This technology implements batch normalization, pooling, and skip layers within the Following Layers. The AI-CP generates Batch Normalizer, Pooler, and Skip Connecter modules to implement these layers.

Within these layers a user has the ability to determine the order, number of, and grouping of layers. The AI-CP must be able to implement the same behavior and functionality as defined by the user. Because of this, the AI-CP does not use a statically defined dataflow process and determines the dataflow according to the user's layer order. In some cases, the user can have combinations of various batch normalization, pooling, or skip layers following each other before a convolution layer. The AI-CP must account for these situations. Alternate embodiments can assume a predefined order of the Following Layer and statically predefine the dataflow process.

The following cases determine the dataflow pathways for the Following Layers. For all series of non-convolution layers within an AI model, such that the series begins immediately after a convolution layer and ends either immediately before the next convolution layer or at the end of the AI model if a convolution layer does not occur beforehand, the correct case is selected according to the following description.

Case NC1, NC meaning non-convolution layer, is selected if all series have no more than one batch normalization, pooling, or skip layers and each layer type maintains its respective order. We define respective order such that for all layer types lt1 that occur before a different layer type lt2 in a series, there exist no other series such that lt1 occurs after lt2. For case NC1 the AI-CP generates one Batch Normalizer if the AI model has at least one batch normalization layer, one Pooler if the AI model has at least one pooling layer, and one Skip Connector if the AI model has at least one skip connection. The modules are then connected according to their respective order.

Case NC2 is selected if all series have no more than one batch normalization, pooling, or skip layers, but the series do not maintain respective order. Therefore, there exists at least one series such that layer type lt1 occurs before layer type lt2 and a second series such that layer type lt1 occurs after lt2. Similar to NC2, the AI-CP generates one Batch Normalizer if the AI model has at least one batch normalization layer, one Pooler if the AI model has at least one pooling layer, and one Skip Connector if the AI model has at least one skip connection. Unlike NC2, the layers do not maintain their respective order. Therefore, the generated Batch Normalizer, Pooler, and Skip Connector are connected to receive data from multiple sources. The current input source for each module must be set by a parameter at run time for each layer.

Case NC 3 is selected if at least one series contains more than one batch normalization, pooling, or skip layers and these layers maintain their approximate respective order. In NC3, for each layer type between batch normalization, pooling, and skip layers, that have more than one instance of the layer type in a series, the AI-CP must optimize whether to generate and instantiate multiple Batch Normalizers, Poolers, and Skip Connectors, respectively, use memory to store intermediate results, or a combination of generating and instantiating multiple modules and using memory to store intermediate results. Generating and instantiating multiple modules includes generating one or more unique modules and instantiating them within the chip design. Using memory to store intermediate results instantiates a memory unit that will store data and pass the data to other Following Layers for further processing. This decreases the amount of other logic components that can consume more power, are limited, and reduces the total amount of logic generated. The AI-CP determines the Following Layer configuration that best meets the user's constraints.

Case NC 4 is selected if at least one series contains more than one batch normalization, pooling, or skip layers and these layers do not maintain their approximate respective order. Case NC 4 is similar to Case NC 3; however, the generated modules must be capable of accepted connections from multiple sources and setting the current source during runtime for each layer.

Following, the functionality of the Batch Normalizer, Pooler, and Skip Connector are defined.

Batch Normalizer

The Batch Normalizer (BN) applies the batch normalization operations for each output layer of the current layer group.

A layer group is a group of layers that the generated chip processes simultaneously. In some embodiments, layer groups within the convolution portion of the CNN begin with either an input modifying layer (including upsampling), deconvolution, or reshaping layers or a convolution layer if an input modifying layer is not encountered. The layer group then adds all layers as it proceeds through the CNN until it has added one convolution layer. The layer group then continues to add layers to the layer group until it has encountered a layer that qualifies as the start of a layer group. Layer groups are then made until all layers within the convolution portion of the CNN have been added to a layer group. In the NN portion of the CNN, the same process is followed except that the start of a layer group can be either a flatten layer or a NN layer, and NN layers take the place of CNN layers.

The BN uses the trained values of μ, σ, γ, β provided in the user's AI model. In some embodiments the values for each are loaded into memory within the BN. Alternate embodiments can store these values in registers or as hard coded or hard-wired values. When an output layer section is finished being calculated and values are propagating through the Following Layers, the BN applies the correct values of μ, σ, γ, β to each value to apply the trained batch normalization function as the values are passed through the BN.

Pooler

The Pooler performs either max, average, min, or global average pooling on the values propagating through the Following Layers. In some embodiments, the AI-CP implements only the needed pooling types for each generated module. If more than one pooling method is used in a Pooler module, a register is set at run time to select the correct pooling function for the given layer group being processed. Alternate embodiments can implement all pooling methods in all pooling modules. The Pooler selects the correct value from a pooling group of values propagating through the Pooler. A pooling group is the incoming output values that will be pooled together. For example, if the pooling width is two and the pooling height is two, then each pooling group is made of a 2×2 group of values such that the first pooling group starts with the top left output value and no pooling groups overlap. Alternate embodiments can start with the first pooling group in other locations of the output layer. The Pooler modules are assisted by the cores which read out their calculated values in a specific pattern such that it reads out the computed values according to pooling groups. The Pooler observes the pooling group, selects or calculates the appropriate value and propagates the value to the next instantiated module within Following Layer.

Skip Connector

The Skip Connector (SC) adds the output of layer l1 to the output of a future layer l2. To implement a skip layer, the Skip Connector loads the previous output from layer l1 and adds the combined filter outputs from l2 to the output of l1. In some embodiments, the previous output l1 is loaded into memory and once the outputs from l2 are propagated to the Skip Connector the outputs from l2 are added to the outputs from II, which are loaded from memory. Alternate embodiments can stream the outputs of l1 from external memory or another memory source on the chip to add the outputs of l1 to the outputs of l2.

Alternate embodiments can use different dataflows within the ROC as long as the result properly calculates an acceptable output for the CNN. Furthermore, alternate embodiments can place functionality of the ROC within the cores as opposed to a central location as in other embodiments.

Data Formatter

The Data Formatter (DF) reads layer input data from either memory, external memory, or the input data source and sends data and metadata to cores and other modules. In some embodiments, the DF reads in data for the input to a layer group since the chip design processes a layer group together. Alternate embodiments can read in and format data from any layer within the AI model.

The core function of the DF is to read in the input to a layer group and broadcast the data and associated metadata. For layers within the convolution portion of the AI model the DF broadcasts the input data value, the x-location, y-location, and layer of the data value. For layers within the NN portion of the AI model, the DF broadcasts the input data value and the values of NN weights.

In addition to the core functionality of broadcasting data and metadata, the DF also implements padding, upsampling layers and deconvolution layers.

Padding is implemented by sending the padding value, typically 0 but can be a different value, along with the associated metadata throughout the chip for locations that are within the padded region. The DF also shifts the x-location and y-location of non-padded regions to account for the padded regions.

Upsampling is implement by broadcasting an input data value multiple times with adjusted location metadata. For an upsampling width (u-width) and upsampling height (u-height), the DF reads out the input data value a total of width*height times incrementing the x-location and y-location accordingly. Once an input data value is broadcast a total of u-width*u-height times, the next input data value is broadcast a total of u-width*u-height times and adjusts the x-location and y-location accordingly. Alternate embodiments can have different broadcasting orders such that the input data is broadcasted to fit the upsampled input. This can include broadcasting all x-locations for a single y-location, or vice versa, as opposed to broadcasting all values for a corresponding upsampled input data value. Alternate embodiments can also implement upsampling by having the cores perform the associated replications of the input data values with the adjusted x-location and y-location.

Deconvolution is implemented in a similar fashion to padding and upsampling. Deconvolution broadcasts the deconvolution value, typically 0 but can be a different value, in all x,y-locations where the deconvolution value occurs and adjusts the x,y-location of input data to the adjusted deconvolution location.

External Memory Reader, Writer, and Controller

The chip generated by the AI-CP interfaces with external memory to read in layer group parameters, commands, or instructions, layer group input data and store layer group intermediate values and layer group output data.

The External Memory Controller (EMC) coordinates with which external memory the External Memory Reader (EMR) and External Memory Writer (EMW) interface. The generated chip allows all components other than the EMC, EMR, and EMW to understand memory buses as either incoming or outgoing without knowing specifically which external memory they address. The EMC abstracts away the details of which external memory units should be read from and which external memory units should be written to. In some embodiments the EMC coordinates having distinct memory units used for reading data, parameters, commands, and instructions (henceforth referred to as reading from) into the chip design and other memory units for writing intermediate values and output values (henceforth referred to as writing to) to memory that are not used for reading data, parameters, commands, and instructions into the chip design. Because of this, the EMC alternates memory units for reading and writing for successive layer groups. This allows the generated chip design to store the output values of a layer group in one or more external memory units and then switch the external memory units at the start of the next layer group to use the previous output values as the inputs to the next layer group. Alternate embodiments can use any combination of memory units for reading in and writing to, can or cannot alternate memory units, and can read from and write to the same memory units. In the case that only a single external memory unit exists, the EMC determines when the EMR can read from the external memory and when the EMW can write to the external memory.

The EMR handles reading from the external memory units selected from the EMC. The EMR receives addresses from various components, reads the data from those external memory addresses, and sends the data received to the either the requesting component or appropriate component to handle the data.

The EMW handles writing to the external memory units selected from the EMC. The EMW receives intermediate values and output layer values, selects the address to write to based on what core and/or Following Layer is reading out data, and writes the received data to the selected external memory address and selected external memory unit. In some embodiments the EMW additionally implements CNN concatenation layers. The EMW writes subsequent filter output layers to subsequent external memory addresses. To concatenate filter output layers, the EMW writes the concatenated output layers such that the filter output layers occur sequentially in the external memory. An alternate embodiment can write the output of concatenated filter layer outputs to various external memory locations as long as the chip design knows the concatenated filter layer output locations upon reading the values in for the next layer.

Finally, there exist scenarios in which the AI model, parameters, commands, and instructions can be loaded entirely into the chip, along with all intermediate processing, without the using external memory. The AI-CP analyzes the size of the values to store in internal and external memory and if the size can be placed entirely within the chip design, then the AI-CP reconfigures the EMC, EMR, and EMW to address memories, or other structures, within the chip design.

Master Controller

The Master Controller (MC) coordinates all activities within the chip design and determines when components begin processing and performing operations. In some embodiments the MC is connected to most, if not all other components while alternate embodiments can use a controller connected to fewer components.

The MC sends the core parameters to each core to identify what portions of the input layer the cores should currently process. The MC sends the layer identifier, x-location start, y-location start, and section size to each core. The MC also sends filter dimensions and filter values to each core for the current filters the core is processing. Additionally, the MC sends each core parameters and commands including the current pooling width, pooling height, stride dimensions, input layer dimensions, and whether the core is processing convolution related layers, depth-wise convolution related layers or NN layers.

The MC connects to the DF and sends the DF parameters to configure how to broadcast incoming data. The MC sends the DF parameters and commands including the current incoming layer dimensions, the current address start and address count, the top, left, bottom, and right padding length, the upsampling width and height, and the deconvolution width and height. In some embodiments, if any of the layers corresponding to the previous stated values are not present in the user's AI model, the AI-CP does not include these parameters and connections in the generated chip design. Alternate embodiments can keep these connections, parameters and registers. The MC also informs the DF of when data is being read in and to start broadcasting data to the chip design. Alternate embodiments can use different logic to determine when data is ready to be broadcast and then start broadcasting the data. The MC also informs the DF during processing NN layers of the incoming layer width and the number of weights to process.

The MC is also connected to the EMC, EMR, and EMW. The MC sends the EMC parameters and commands including what layer is currently being processed so that the EMC knows which external memory units should be read from and which external memory units should be written to. The MC sends the EMR parameters and commands including when to begin reading in data from which input layer, which intermediate outputs, and which previous layers for skip layers. The MC sends the EMW parameters and commands (including the external memory start addresses) for each core and which cores or memories within the DOC are currently reading out so that the EMW can determine the external memory address to write to.

The MC sends to the DOC parameters and commands, including which cores are processing which layers and which core outputs to combine. The MC also informs the DOC of when cores begin to read out so that the DOC knows which outputs to combine.

The MC sends the AF parameters and commands regarding which activation function to use for the current layer group being processed.

The MC also connects to the Following Layers and sets the dataflow between modules within the Following Layers if the Following Layers are within cases NC2 or NC4. The MC sends the Poolers parameters and commands, including what type of pooling to perform, the pooling width, the pooling height, and whether pooling is used for the current layer group output values propagating through the Following Layers. The MC sends the BNs parameters and commands including the values of μ, σ, γ, β and whether batch normalization is used for the current layer group output values propagating through the Following Layers. And finally, the MC sends the SCs parameters and commands including which layers' outputs to sum together, the values of the previous layer to add to the current layer group output values propagating through the Following Layers, and whether skip layers are used in the current layer group.

Lastly, the MC keeps track of when to execute operations, schedules operations within the chip design, and interprets commands and instructions loaded from external memory. In some embodiments the MC executes and schedules operations using counters and timers, along with interpreting commands to set different counter and timer values to know when to start operations. Alternate embodiments can use counters or timers with values set ahead of time or by using logic to determine their values or logic to determine when various operations are ready to be executed. When commands and instructions are read in, the MC parses the commands and sets the appropriate registers and parameters or begins the appropriate operations.

### Deep Learning Chip Generation

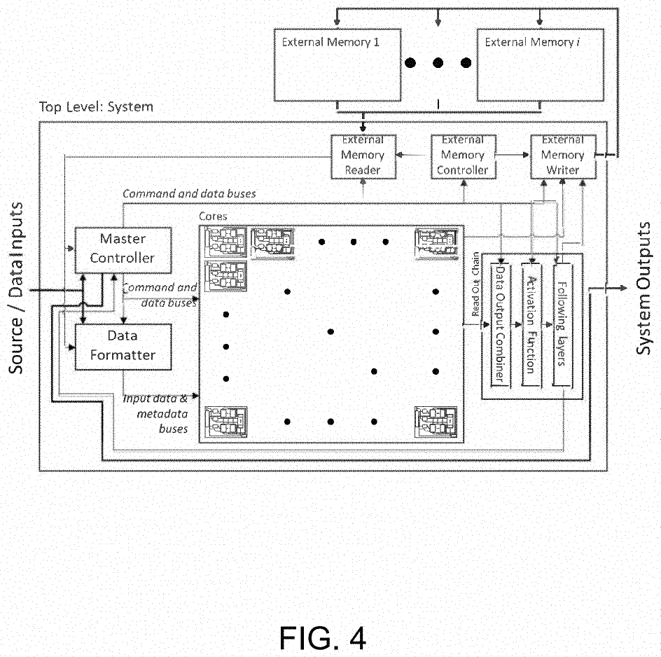

The third part of the technology is the AI-CP that generates the chip design that implements the computations for an AI inference as exemplarily shown in FIG. 4. It has been previously discussed that different components will be generated within the chip design and their function. In this section, it is described how the AI-CP generates these components and what the output contains. In some embodiments the AI-CP generates the entire chip design algorithmically for a trained AI model. However, an alternate embodiment can easily start with a chip design shell for common tasks and generate most or a portion of the chip design. Other embodiments instead create the entire chip design manually. As previously stated, alternate embodiments of the technology can pertain to multiple forms of chip design. In some embodiments, the output is in the form of HDL code. The generated chip design follows the architecture shown in FIG. 4.

### Determine Core Resources and Core Count

The first step in generating the hardware description is to determine the configuration for the core and generate the core's hardware description. To do this, the AI-CP examines the resources the user has provided and determines how many resources will be used for non-core components and how many resources will be allocated for the cores. The resources analyzed in the following discussion, as pertaining to the cores, will refer to the resources the AI-CP has determined can be used by the cores. The core count (C) is then determined as is the number of cores that will be instantiated, as well as the data memory count (C_{DM}), the MAC memory count (C_{MM}), and the DSP slice count (C_{DSP}) that will be assigned to each core. C_{DM}, C_{MM}, and C_{DSP} are assigned on a per core basis. Alternate embodiments can use the same value of C_{DM}, C_{MM}, and C_{DSP} for each core. The inputs to this calculation are the number of total DSP slices (n_{DSP}) and the number of total memory units (n_{MU}) provided by the user. A memory unit is a memory component that has a number of memory locations that can be interfaced with some or all of the following, which can be in addition to other signals: an address port, a write port, a data in port, and a data out port. To determine the number of cores, a combination is analyzed of the minimum number of cores the DSP slices will support and the number of cores that can contain two data memories and two MAC memories. Alternate embodiments, including those that utilize MAC reduction and that are discussed below, can perform this analysis with different values for the number of data memories and MAC memories, but will follow similar methods with those different values. Some embodiments use zero MAC memories in which the calculations would use a value of zero for C_{MM}.

The following calculations determine the minimum number of cores the DSP slices will support. First, the number of values is calculated that a memory unit can read out per UoT (ν). For example, a memory unit with a data port width (d) of 16 bits, a value bit width (b) of 8 bits and dual port access would be able to read out four values per unit of time. This is accomplished as follows:

$$v = \frac{d}{b} * number of ports$$

The maximum number of DSP slices per core is equal to ν. Alternate embodiments can determine ν through alternative calculations. Therefore, the minimum number of cores the DSP slices support (DSP Cores) is:

$$DSP Cores = ⌊ \frac{{n}_{D S P}}{v} ⌋$$

The second step is to determine the number of cores that can contain two data memories and two MAC memories (Memory Cores). As stated previously, alternate embodiment can use different values. In the equation, 2_{DM} is used to show the two data memories and 2 mm to show the two MAC memories. This is determined as follows:

$$Memory Cores = ⌊ \frac{{n}_{M B}}{{2}_{D M} + {2}_{M M}} ⌋$$

For both DSP Cores and Memory Cores, other embodiments do not use the floor operation; however, for simplicity and parallel core operations, it has been determined better to use the floor operation most often.

After calculating DSP Cores and Memory Cores there are two cases to consider. Case 1: Memory Cores≥DSP Cores. Case 2: DSP Cores<Memory Cores.

For Case 1, we identify two subcases. Case 1.1 is selected if ν is one or Memory Cores<2*DSP Cores, and we set C to Memory Cores. Under these conditions, each core sets C_{DM} to two, C_{DSP} to ν, and C_{MM} will be set initially to two. If n_{MU} is greater than 4*C, each core's C_{DM} will be incremented by one in a round robin fashion until:

$${\sum }_{i = 1}^{C} {C}_{D M}^{i} + {C}_{M M}^{i} = {n}_{M B} \qquad Eq . 1$$

where Cⁱ denotes the i^{th} core also referred to as core i, C_{DM}ⁱ denotes the number of data memories assigned to core i, and C_{MM}ⁱ denotes the number of MAC memories assigned to core i.

For Case 1, case 1.2 is selected if ν>1 and Memory Cores≥2*DSP Cores, and we set C as follows:

$$C = ⌊ \frac{Memory Cores}{n} ⌋$$

$$where n = arg max ( \begin{matrix}Memorys Cores mod n = 0 \\ and \\ v mod n = 0\end{matrix} )$$

$$such that n ϵ Z$$

For each core, C_{DM} is initially set to 2, C_{DSP} is set to ν/n, and C_{MM} is set to 2. Then, each core's C_{DM} will be incremented by 1 in a round robin fashion until Eq. 1 is satisfied.

For Case 2, when Memory Cores is less than DSP Cores, we determine C as follows: the objective is to achieve the maximal computation throughput. Therefore, the main objective is to maximize DSP slice utilization, but this must be balanced against computation overhead. The following subcases are identified and each subcase's overall throughput is evaluated.

In case 2.1, C is set equal to DSP Cores. For each core C_{DSP} is set to ν. For the first n number of cores, where n is equal to Memory Cores, C_{DM} is set to two and C_{MM} is initially set to two. For the remaining m cores, where m is equal to DSP Cores−n, C_{DM} is set to zero and C_{MM} is set to zero. For each of the first n cores, and only the first n cores, we increment C_{DM} in a round robin fashion until Eq. 1 is satisfied. Effectively, case 2.1 follows case 1.1 and uses the excess DSP slices for NN layer computations.

In case 2.2, C is set equal to DSP Cores. For each core, the following is set: C_{DM} to 2, C_{DSP} to ν, and C_{MM} to 0. Then, C_{MM} for each core is incremented by 2 in a round robin fashion as long as Eq. 2 remains true. If incrementing C_{MM} by 2 for a core will invalidate the inequality, C_{MM} is not incremented by 2 and the round robin process is stopped.

$${\sum }_{i = 1}^{C} {C}_{D M}^{i} + {C}_{M M}^{i} \leq {n}_{M B} - 2 \qquad Eq . 2$$

Case 2.2 is only valid if n_{MU}−2≥2*DSP Cores. Case 2.2 will have one or more cores without MAC memories, otherwise case 1 would be valid. Case 2.2 reserves ν memory units for combined output of the cores without MAC memories. The output of these cores is then combined and stored in the reserved memory unit.

In case 2.3, C is set to DSP Cores. For each core, C_{DM} is set to zero, C_{DSP} to ν, and C_{MM} to zero. C_{DM} is then incremented by 1 in a round robin fashion until each core's C_{DM} equals two or Eq. 3 is satisfied, whichever occurs first.

$${\sum }_{i = 1}^{C} {C}_{D M}^{i} = {n}_{M B} - 2 \qquad Eq . 3$$

After this, each core's C_{MM} is incremented by two in a round robin fashion as long as Eq. 2 remains true. If incrementing C_{MM} by two for a core will invalidate the inequality, C_{MM} is not incremented by two and the round robin process is stopped. Although case 2.3 is always a valid approach, it is primarily used when there are not enough memory units to assign two data memories to each core. Therefore, it is most likely that some cores will only have one data memory, and likely that no cores will have MAC memories. Case 2.3 must also reserve two memory units for combined output. If cores are assigned zero data memories, they can still be instantiated for NN layers. Case 2.3 can also be used if the AI-CP determines that the preferred design combines all the results in the Data Output Combiner and/or the reserved memories for combined outputs.

To determine which subcase to select and assign C, C_{DM}, C_{MM}, and C_{DSP}, the throughput of each subcase is analyzed. Throughput (T) is analyzed as a ratio of the UoT that calculations are being performed (L) to the total UoTs, which is the combined overhead (tₕ) and calculation time (t_{c}). This is defined in Eq. 4, where selection is made between subcases 2.1, 2.2, or 2.3 based on which subcase has the highest T

$$T = \frac{{t}_{c}}{{t}_{c} + {t}_{h}} \qquad Eq . 4$$

For each subcase, Eq. 4 is analyzed regarding the total number of convolution calculations (x_{c}), the total number of NN calculations (xₙ). t_{c} is then a combination of the UoTs for computing the convolution operations (L_{cc}) and the UoTs for computing the NN operations (t_{cn}). Similarly, tₕ is a combination of the UoTs for convolution overhead operations (t_{hc}) and the UoTs for NN overhead operations (tₕₙ). However, some embodiments have no impactful overhead for NN operations, thus tₕₙ=0 for all subcases. Therefore, t_{c}=t_{cc}+t_{cn} and tₕ=t_{hc}. Additionally, C_{DSP}ⁱ denotes the number of DSP slices assigned to core i, ext_{ν} denotes the number values that can be input per UoT from external memory, size(DMᵢ^{j}) denotes the number memory address in the j^{th} data memory of core i, size(MMᵢ^{j}) denotes the number of memory address in the j^{th} MAC memory of core i, and n_{SS} denotes the number of sections that will be processed.

For each subcase, t_{cc} and t_{cn} are equal to or are proportionate to t_{cc}′ and t_{cn}′ shown in Eq. 5 and Eq. 6, respectively.

$${t}_{cc}^{′} = \frac{{x}_{c}}{{\sum }_{i = 1}^{C} {1}_{{C}_{D M}^{i} > 0} * {C}_{D S P}^{i}} \qquad Eq . 5$$

$${t}_{cn}^{′} = \frac{{x}_{n}}{max ( {n}_{DSP} , {ext}_{v} )} \qquad Eq . 6$$

For subcase 2.1, t_{cc}=t_{cc}′, t_{cn}=t_{cn}′, and t_{hc} is calculated according to Eq. 7. The convolution overhead is equal to the sum of the size of the first data memory for each core that has a data memory.

t_{hc}=Σᵢ₌₁^{C}1_{C}_{_{DM}}_{ⁱ}>0*size(DMᵢ¹) Eq. 7

For subcases 2.2 and 2.3, some of the cores will have zero MAC memories and will rely on the combined MAC memory. With this configuration, the cores with zero MAC memories must process different layers of the same section. Because of this, there will be situations where some cores have no section assigned to them for processing. We denote n_{SS}⁰ as the number of times that a core is assigned no section to process. Therefore, for subcases 2.2 and 2.3:

$${t}_{c c} = \frac{{n}_{SS} + {n}_{SS}^{0}}{{n}_{SS}} * {t}_{cc}^{′} \qquad Eq . 8$$

For subcase 2.2, t_{cn}′=t_{cn}, and t_{hc} is calculated according to Eq. 9. The summation is similar to Eq. 7 and is equal to the sum of the size of the first data memory for each core, with the difference being that every core has a data memory.

t_{hc}=Σᵢ₌₁^{C}size(DMᵢ¹) Eq. 9

For subcase 2.3, t_{cn}′=t_{cn}, and t_{hc} is calculated according to Eq. 10. The first summation is similar to Eq. 7 and incurs overhead equal to the size of the first data memory for each core with more than one data memory. The second portion of the equation incurs overhead in each core with only one data memory each time new input data is stored. This happens because the data memory cannot be multiple buffered. We multiply the percentage of cores with one data memory times the number of sections and multiply this by the sum of the first data memories for each core with only one data memory.

$${t}_{h c} = {\sum }_{i = 1}^{C} {1}_{{C}_{D M}^{i} > 1} * size ( {DM}_{i}^{1} ) + {n}_{S S} * \frac{{\sum }_{i = 1}^{C} {1}_{{C}_{D M}^{i} = 1}}{C} * {\sum }_{i = 1}^{C} {1}_{{C}_{D M}^{i} = 1} * size ( {DM}_{i}^{1} ) \qquad Eq . 10$$

For case 2, each subcase is analyzed and the subcase that produces the largest T is selected along with its values of C, C_{DM} C_{MM}, and C_{DSP}.

Some embodiments compute each of these values based on the number of resources present; however, an alternate embodiment can follow a different procedure to determine these values, determine these values manually, or even establish these values a priori. Alternate embodiments can select a certain architecture for ease of implementation or can choose a different metric to optimize over such as reducing the number of external memory reads and writes or reducing overall power consumption.

### Generate HDL Core Modules

Once the values of C, C_{DM}, C_{MM}, and C_{DSP} are set, the next step is to generate the design of each core within the HDL code base. Each core must instantiate the correct number of data memories, MAC memories, and DSP slices and correctly connect the components. Additionally, each core must be connected to data input, command, and read out buses and signals. Alternate embodiments can use more or fewer buses or signals to connect to the instantiated core, nevertheless the process would be very similar.

The first step is to determine the number of unique core configurations (U). A core configuration is defined as the values of C_{DM}, C_{MM}, and C_{DSP} for a core. Two configurations, C1 and C2, are identical if:

C_{DM}¹=C_{DM}²

C_{MM}¹=C_{MM}²

C_{DSP}¹=C_{DSP}²

size(DMᵢ¹)=size(DM₂ⁱ),1≤i≤min(C_{DM}¹,C_{DM}²)

size(MMᵢ¹)=size(MM₂ⁱ),1≤i≤min(C_{MM}¹,C_{MM}²) Eq. 11

In Eq. 11, the subscripts and superscripts of 1 and 2 correspond to C1 and C2, respectively. To determine U, each configuration is compared to each other configuration and a list of the unique configurations is generated.

All connections completed during core generation or instantiation are performed using the auto-routing and attribute capabilities of ADE.

For each unique configuration generated, a unique HDL core module (HCM) with the corresponding C_{DM}, C_{MM}, and C_{DSP} values. Within each of these HCMs, the needed number of data memories are instantiated as MAC memories and DSP slices. Additionally, the data memory controller, MAC memory controller, NN controller, read out selector, and core controller must be generated. To begin generating each HCM, an empty HDL module is generated and given a unique name. In some embodiments, the name is assigned based on the C_{DM}, C_{MM}, and C_{DSP} values. For example, an HCM with C_{DM}=2, C_{MM}=3 and C_{DSP}=4 would generate the empty module as indicated immediately below. Alternate embodiments can name the HCMs using a different scheme or even randomly generated identifiers.
module Core_2_3_4 #( )( );
endmodule

Next, each data memory is instantiated. This is done using ADE to add the instantiated data memory modules to the HCM. For example, if C_{DM}=2, then ADE algorithmically adds two instantiated data memories as indicated in the code immediately below.
module Core_2_3_4 #( ) ( );
   DataMemory dataMemory1 #( ) ( );
   DataMemory dataMemory2 #( ) ( );
endmodule

In a similar manner, a MAC memory and DSP slice is instantiated within each HCM. The DSP slices are contained inside of either a MAC module or a multiply module. This is because there is added logic to handle when operations should or should not be performed. Most often the MAC modules are used as opposed to multiply modules. MAC modules are used when the C_{MM} for the core being generated is greater than zero and multiply modules are used when C_{MM} for the core being generated is equal to zero. Additionally, if MAC reduction is being used, multiply modules are used.

Next, the data memory controller, MAC memory controller, NN controller, and core controllers are generated. Each of these controllers is generated algorithmically using ADE. Each of them relies on dynamic configurations and create the respective HDL code to implement the given configuration. The data memory controller is generated algorithmically to operate C_{DM} data memories and whether to store the intermediate results of NN operations. Similarly, the MAC memory controller is generated algorithmically to operate C_{MM} MAC memories and whether to store the intermediate results of NN operations. The NN controller is generated algorithmically to operate C_{DSP} MACS and use either the data memories, MAC memories, or neither to store intermediate results. Other embodiments can perform NN operations outside of a core, and therefore generate only some, if any, of the NN controller.

The read-out controller is generated based on the values of C_{DM} and C_{MM}. The core controller is generated to include any parameters or registers that will be set through commands declared in the data memories, MAC memories, data memory controller, MAC memory controller, NN controller, or any other logic within the core that are not explicitly global registers. The core controller is also generated to communicate messages to the other instantiated modules regarding processing or other needed signaling.

In some embodiments these are discrete components, however alternate embodiments can organize the components in a different manner or simply combine some of the logic into only one, or more than one, component. The logic being generated is what enables the core to function as expected and alternate embodiments can generate, or manually create, similar logic in a different modular structure.

Once generated, the different components must be connected such that the core is able to process the needed calculations. Each data memory is connected to the data memory controller that determines which data memory should be storing incoming data, what incoming data to store, and when to process each of the data memories. Similarly, each MAC memory is connected to the MAC memory controller that determines which MAC memory is performing computations and storing intermediate results, reading out finished results, or waiting to be processed. The outputs of both the data memory and MAC memory are connected to the inputs of the MACs. Also, the outputs of each data memory, MAC memory, and MAC module are connected to the read-out controller if the respective components need to send data out of the core.

The correct bits of the data memories and MAC memories are routed to the correct inputs of the DSP slices. For example, if ν is four, and there are four DSP slices assigned to the core, then the bits correspond to the 1^{st} value from the data memory and MAC memory are routed to the first DSP slice, and similarly done for the second, third, and fourth values. The outputs of each DSP slice are routed to each MAC memory, and each data memory if the design requires it for NN operations. Each data memory and MAC memory need to be connected to the outputs of each DSP slice and ADE correctly routes the DSP slice outputs to the correct memory input bits to be stored appropriately according to the designed HCM modules. Additionally, if the user's AI model contains depth-wise convolutions, the AI-CP generates logic as follows. The AI-CP generates a multiplexer to select the output of either the data memory or MAC memory as the multiplier input to the DSP slice and generates a multiplexer to select either the MAC memory's output or zero as the accumulate input to the DSP slice. The AI-CP generates logic to set the control of the two multiplexers such that if the second filter of a depth-wise convolution, the one in which the output layers will be combined, is being processed, the selected multiplier input will be the MAC memory output and the selected accumulate input will be zero. Otherwise, the selected multiplier input will be the data memory output and the selected accumulate input will be the MAC memory output.

Furthermore, for each unique core configuration, the HCM must connect the data memories, MAC memories, and DSP slices to the core controller logic. The core controller logic is connected to the command bus and receives commands, such as when to begin processing calculations, when to begin storing data and parameters such as the section to process, the filter size and the like. Each data memory, MAC memory, and DSP slice is connected to the pertinent parameters and logic is designed for each that processes pertinent commands.

Finally, for each unique core configuration, the HCM must be able to input data and output results. Input ports are generated for the data input and command buses and signals. The command buses and signals are routed to the core controller logic. The core controller logic is generated to understand commands from the command bus and signals and set the associated parameters or other operations that the commands would request. The core controller is also connected to global registers, if any, as needed to perform the HCM's operations. In some embodiments the global registers are placed in the master controller; however, an alternate embodiment can place global parameters in any location.

Using ADE, each core controller can connect to a parameter located anywhere in the generated HDL. Each HCM's core controller is also connected to receive a read request signal from the master controller. Logic is generated within the core controller to read out the correct memory or values once a read request is received. Each core controller is also connected to data and metadata buses from the DF. The DF receives data either from the system source/data inputs or the EMR. The data will contain values from the input to each layer, regardless of the layer type. The metadata will contain information such as the location of the data within an input image or input layer. Once the core controller receives data and metadata it routes the data to the correct data memory, MAC memory, or MAC or multiply modules.

An alternate embodiment would not generate the cores dynamically, but statically create or partially generate the different unique HCMs from the different combinations of various C_{DM}, C_{MM}, and C_{DSP} cores and instantiate the HCMs.

### Generate HDL Non-Core Modules

Once each HCM is generated the remaining modules and components are generated.

### Data Output Combiner

The Data Output Combiner (DOC, as previously defined) is the first module in the ROC and combines the outputs of the HCMs as appropriate. To do this, the DOC connects to the output of each of the to be instantiated core, connects to and observes the read-out requests to each core, generates a binary tree of adders, generates memory to store and recall previous filter layer outputs and sends values to the next module in the ROC.

First, the DOC is connected to the output values of each of the to be instantiated cores and is connected to each read out request to observe the read-out requests. The AI-CP generates variables in in the DOC such that there is one variable for each core output and one variable for each read request. The AI-CP will later use ADE to auto-route these variables to where the value of signal is generated.

Once each output is generated, the AI-CP generates a binary adder tree to sum together the core outputs. The AI-CP pairs together the core outputs such that each core output is in one, and only one, pair to create the first layer of adders within the binary adder tree. If there is an odd number of core outputs, one output is not placed in a pair, but is forwarded to the next layer of the binary adder tree. For each pair, the AI-CP generates an adder and connects each of the core outputs in the pair to the inputs of the adder. The process of pairing values, generating adders, and connecting inputs is repeated to create a new layer of adders; however, this time it is the outputs of the previous adder layer that are paired and connected to newly generated adders. Again, an odd number of values results in the last value being forwarded to the next layer of the binary adder tree. This process is repeated recursively for each layer of adders until there is only one adder, an even number of inputs, and one output value. This final output value is the output of the binary adder tree.

In some embodiments, the entire binary adder tree is executed in a single UoT. Alternate embodiments can perform depth analysis and generate and insert registers into the binary adder tree such that values can be held and calculation occur over multiple UoTs. Alternate embodiments can perform shifting between the addition layers to prevent overflow or dynamic shifting if any value within the binary adder tree reaches a certain bit width. Another alternative is to sum the output values over multiple UoTs using synchronous logic or generating adders in a wider tree or non-tree structure.

Once the binary adder tree's value has been produced, it can be the final value for the filter's convolution output. Depending on C and each core's C_{DM}, the filter can have too many layers for all filter layers to be processed at once. In the event that all filter layers can be processed at once, the output of the binary adder tree is the final value of the filter's convolution output and is sent to the next module in the ROC to be processed. However, if the opposite is true and the filter layers cannot all be processed at once, then the output of the binary adder tree is an intermediate value that must be stored for later recall. In the cases where a filter's convolution output is processed in stages and a filter cannot be processed all at once, it will be processed in s stages. For the stage 1, the binary adder tree's output is forwarded through the remaining ROC modules, is not processed in those modules and is sent to the EMW. In stage 2 through stage s−1, the values that were sent to the EMW are read into the DOC from the EMR and MC and stored locally in memory in the DOC. The binary adder tree's outputs for stages 2 through s−1 are added to the corresponding values stored within the DOC's memory and forwarded through the remaining ROC modules unprocessed to the EMW. For the last stage, stage s, the same process is followed as stages 2 through s−1, except that once the value is added to the value from the DOC's local memory, it is the filter's final convolution value. The output value is then forwarded to the remaining ROC modules along with a signal indicating that the value is ready to be processed.

To implement the stages, the AI-CP instantiates the memory unit (or units) within the DOC and generates the associated logic. Depending on the schedule created by the AI-CP and resources, the DOC can contain multiple memory units to buffer intermediate values. To generate the logic that the AI-CP generates, a global register is set that determines how many stages are currently needed. Then, the AI-CP generates a counter to track the current stage. Finally, the AI-CP generates logic to read and store values in the memory unit. The generated logic receives a signal from the MC to store data in the memory. When storing the incoming data the AI-CP generates logic to start at the first memory address and sequentially store the incoming data. When convolution values are being read out and propagated through the binary adder tree, the binary adder tree's final value is added to the corresponding local memory value. The AI-CP generates logic such that during stage 1 no local memory values are read out. The AI-CP also generates logic such that during stages other than stage 1, the local memory reads out the correct memory location. The AI-CP then generates an adder (final adder) and logic to add the binary adder tree's output to the output value from the DOC's local memory. Finally, the AI-CP generates a multiplexer using the current stage as the control such that in stage 1 the binary adder tree's output is forwarded to the rest of the ROC and in all other stages the value from the final adder is forwarded to the rest of the ROC. A multiplexer is a chip design component that can select between multiple inputs using a control signal or bus.

In addition to producing the final convolution output, the DOC also sends a ready signal to the next module in the ROC to indicate that the value produced is ready for further processing. The AI-CP generates this signal by generating counters and ripple registers based upon when the DOC receives a value. A ripple register is a series of registers that each track its previous register such that for each UoT the next ripple register sets its value to that of the previous ripple register. Alternatively, and instead of using the previous register, when the data from cores is the result of NN operations, the DOC forwards the data to the remainder of the ROC to be processed. The AI-CP generates logic for a ready signal for the NN values, as well. Still further, the AI-CP also generates logic to receive a bias value and apply it to the finished output,

### Activation Functions

The Activation Function (AF) is the second module in the ROC. To generate the AF, the AI-CP analyzes the activation functions present in the user's AI model: (a) generates the chip design structure that implements the activation functions present in the user's AI model, and (b) generates chip design components that select the correct activation functions and correct dataflow for the current layer group.

First, the AF generates a register for the current activation function that is being used for the current layer group. In some embodiments the register is generated as a global register within the MC and auto-routed to the AF using ADE. Other embodiments can generate a register within the AF or other logic is utilized, such as counters, to determine which activation function to use.

The AF receives the values from the output of the DOC. A connection is generated to receive the DOC's value and is auto-routed using ADE. In some embodiments, a connection is also generated and auto-routed depending on whether the DOC is reading out and whether the value is ready to be processed by the AF and FL. Still further, other embodiments avoid sending values that are not ready to be processed through the AF and FL by using various forms of logic and processing to determine when a value is ready to be processed by the AF.

Next, the AI-CP analyzes the user's AI model and records all activation functions that are present. For each activation function, the AI-CP determines how many multiplications are to be used. Each multiplication is reviewed to determine if a DSP slice is needed or whether the multiplication can be performed through other methods. If both multiplication factors are unknown at compile time, then a DSP slice is needed. Compile time is defined as the period when the AI-CP is generating the chip design, instantiating components, and creating the schedule. Run time is defined as the period when the chip design is being used to perform AI inferencing. For multiplications where one multiplication factor is known at compile time, a DSP slice can be utilized, but is not always required. If the known multiplication factor has a limited number of 1's in its binary representation, the AI-CP can replace the multiplications with any number of factors unknown at compile time by generating a few adders. For example, if an unknown factor is being multiplied by six, the AI-CP can generate logic that performs the following instead of instantiating a DSP slice. To multiply by six, the AI-CP can generate logic that (a) multiplies the unknown factor by four by left shifting the unknown factor by two, (b) multiplies the unknown factor by 2 by left shifting the unknown by one and (c) adding the result of the two shifts. The AI-CP determines whether a DSP slice is needed or whether the multiplication should be performed through a different method as described above. Once each multiplication has been analyzed, the AI-CP sets the maximum number of DSP slices needed to that of the activation function that needs the most DSP slices. Alternate embodiments can use various methods to account for multiplication and avoid some (or all) of the DSP slice usage incurred in other embodiments. An example is approximating factors as powers of 2 such that shifting can be used exclusively.

After this, the AI-CP generates outputs for each DSP slice. The outputs of each DSP slice can be the final outputs for an activation function, or they can be used for further calculations. If any activation function requires further additions or shifts after a DSP slice outputs a value, the values are generated along with the appropriate additions or shifts.

Next, the AI-CP generates inputs to the DPS slices for each activation function. The AI-CP generates any known values, additions, or shifts that are required to accompany the inputs. The AI-CP receives these operations and values from the activation functions included in the user's AI model. For each input in which additions and shifts are performed, the AI-CP can generate multiple sequential or parallel values. Inputs for each activation function are passed through a multiplexer that determines the correct DSP input for the current activation function selected with the global register. An input can use the output of a previous DSP slice.

The AI-CP then instantiates a number of DSP slices equal to the maximum number of DSP slices needed. The AI-CP connects the DSP slice inputs and DSP slice outputs. In some embodiments the AI-CP instantiates a DSP slice for each DSP slice used. This allows the AF to pipeline use of the DSP slices. Alternate embodiments can reuse DSP slices for multiple operations while processing a single input value. These alternate versions must generate additional logic to determine which input values to use for the DSP slice based on the stage of the activation function that is being processed.

Next, the AI-CP generates logic to determine the final output of the AF. If the AF only needs to implement a single activation function, then that value is used as the AF output. If multiple activation functions are generated, the AI-CP generates a multiplexer and logic to select the correct output value based on the current activation function.

Finally, the AI-CP generates counters or ripple registers to determine when the AF's output value is ready. For each activation, the AI-CP determines how many UoTs are needed for the activation to produce its output value. The AI-CP generates: (a) one or more counters or ripple registers to track the needed UoTs until the AF output value is ready and (b) a ready signal. Once the counters or ripple registers have determined that output is ready, the AF sends the current activation function's output value and an output ready signal to the next module in the ROC. Alternate embodiments can use other forms of logic to determine when an output value is ready such as a global counter or a signal from a DSP slice that signals when the computations have completed. However, if an alternate embodiment cannot send an output ready signal, it may instead determine that a value is ready using other logic such as a global counter or otherwise determine that the output value is not the maximum or minimum possible value.

Though many activation functions are calculated using DSP slices, logic, shifts and additions, some activation functions can be implemented through other methods. In particular, some mathematical operations are challenging to perform in an embedded environment, such as the sigmoid operation. For these operations, the AI-CP generates a lookup table. The lookup table can be populated at run time or at compile time. A lookup table populated at run time will be provided with values for the lookup table and can change during the AI model's execution. Additionally, the AI-CP can instantiate one or more memory units and store the lookup table values in the memory units. If the lookup table is determined at compile time, the AI-CP will generate logic that implements the lookup table and the lookup table cannot be changed at run time.

### Following Layers

The modules in the Following Layers are only generated and instantiated if they are present within the user's AI model. Some embodiments generate and instantiates the next components and values in the order described. Alternate embodiments can follow different orders.

When generating the BN, P, and SC modules, the AI-CP separates the previously decided case of either NC1, NC2, NC3, and NC4 into subcases for the BN, P, and SC modules. This results in a subcase for the BN modules, NC1-bn, NC2-bn, NC3-bn, and NC4-bn, a subcase for the P modules, NC1-p, NC2-p, NC3-p, and NC4-p, and a subcase for the SC modules, NC1-sc, NC2-sc, NC3-sc, and NC4-sc. Each subcase is determined following the same rules as used for choosing between NC1, NC2, NC3, and NC4, except that the determination is only analyzed for the associated module type.

### Batch Normalizer

The Batch Normalizer (BN) implements the batch normalization functionality of CNNs. To generate the BN, the AI-CP generates the needed memory units and logic, DSP slices and associated logic, and generates incoming data connections. If the user's AI model contains no batch normalization layers, the BN is not generated or instantiated.

First, the AI-CP generates a global register that indicates which filter is currently being read out. Some embodiments generate the register within the MC and autoroutes the connection using ADE. However, alternate embodiments can place the register as desired or can detect the current filter through other means such as using counters or observing particular signals.

To instantiate the memory units and generate associated logic, the AI-CP first determines the maximum number of batch normalization parameters per parameter type per batch normalization layer contained in the user's AI model. The AI model should contain the same number of each μ, σ, γ, β parameter within a batch normalization layer. The AI-CP looks at each batch normalization layer and determines the maximum number of each μ, σ, γ, β parameter for a single batch normalization layer. The AI-CP then uses this maximum, along with other factors, to determine how many memory units to generate. In addition to the maximums, the AI-CP can also determine: (a) whether the user has given a preference for either a reduced footprint or greatest throughput, (b) whether a required inferences per second is given, and (c) the number of resources provided.

If any of the following conditions are met, then the AI-CP will instantiate two memory units and store the values for two batch normalization parameters in each memory unit referred to as case BN1. If none of the following conditions are met, then the AI-CP will instantiate one or more memory units for each batch normalization parameter referred to as case BN2. The Conditions are: (a) If the maximum number of each parameter is small enough such that the number of memory addresses in the memory unit to be instantiated is twice the maximum number of each parameter. (b) If the user has a preference for a reduced footprint and has not set a required inferences per second. (c) If the user has a preference for a reduced footprint, has set a required inferences per second, and the computation schedule can add in the extra batch normalization read ins without violating the required inferences per second. (d) If more than two memory units are used, will that negatively impact the ability of the other modules to perform their functions.

Once the AI-CP has determined that the memory generation is either case BN1 or BN2, the AI-CP instantiates the appropriate number of memory units. In the case of BN1, the AI-CP instantiates two memory units. In the case of BN2, the AI-CP instantiates at least one memory unit per μ, σ, γ, β parameter. If the maximum number of each parameter is less than the number of memory addresses in a memory unit, then the AI-CP will instantiate four memory units, one for each per μ, σ, γ, β parameter. However, if the maximum number of each parameter is greater than the number of memory addresses in a memory unit, the AI-CP determines the following: if the AI-CP can schedule additional batch normalization read ins without reducing the inferences per second below a required amount, or the required inferences per second is not set, and using the needed additional memory units will not negatively impact the ability of the other modules to perform their functions. Based thereupon, the AI-CP instantiates m_{BN} memory units for each μ, σ, γ, β parameter according to the following formula:

$${m}_{B N} = ⌈ \frac{maximum number of each parameter}{m emory addresses per memory element} ⌉ \qquad Eq . 12$$

Next, the AI-CP generates the logic that accompanies the memory units. The AI-CP will generate memory read and write signals to store incoming data and read from the memory according to the current filter being processed.

First, the case in which two parameters are stored in the same memory unit is described as case BN1. In the BN1 case, each parameter assigned to a memory unit will use one of the memory unit's dual port accesses. The AI-CP generates memory interface signals for each μ, σ, γ, β and connects each set of memory interface signals to one memory port. For each parameter, the AI-CP generates logic to take data coming from the MC and store that data in the memory unit. Since these memory units store data for two parameters, in at least some embodiments one parameter is stored in the lower half of the memory unit and the other parameter is stored in the upper half of the memory unit. For the parameter stored in the lower half of memory, the generated logic begins to store data from the MC at address 0 while the other parameter begins to store data from the MC at the address that is equal to half the memory size. For each parameter, the AI-CP also generates logic to set the memory address to the address that corresponds to the current filter. In some embodiments, the memory address that correlates to the current filter for parameters stored in the lower half is the current filter number, which starts at 0. The memory address that correlates to the current filter for parameters stored in the upper half of memory are the current filter number plus half the memory size. Alternate embodiments can use different memory mappings for both storing and reading data. Alternate embodiments might use only a single memory port, and if so, multiple UoTs are used to write and read data or to store values for both parameters. Furthermore, alternate embodiments can store more than two parameters in a single memory unit depending on the number of parameter values to be stored and reduce the bit width of parameter values.

For case BN2, the AI-CP generates similar logic. When each parameter is assigned one memory unit, the AI-CP generates the memory writing logic using one memory port and generates the memory reading logic using the other memory port. Alternate embodiments can use one memory port for both functions. For the memory port that reads data sent from the MC and stores the data in the memory unit, the AI-CP generates read and write signals that take data sent from the MC and stores them in the memory unit such that the first parameter value is stored in address 0 and each successive parameter value is stored in respective successive memory addresses. For the memory port that reads data from the memory unit, the AI-CP generates read and write signals that set the memory address to the value of the current filter number, starting at 0. Similar to case BN1, alternative embodiments can use different mapping schemes. Additionally, alternative embodiments can access data across multiple UoT if necessary, or store multiple parameter values at a single memory location, if possible.

For other BN2 cases in which each parameter is assigned multiple memory units, the AI-CP generates similar logic to that described above regarding the BN2 case. The difference between these two cases is that when the generated read and write logic overflows a memory unit, the AI-CP generates logic to move the reading or writing logic to the next assigned memory unit. Similarly, alternate embodiments can use various memory mappings.

In some embodiments the AI-CP scales and quantizes all μ, σ, γ, β parameters from the user's AI model. The AI-CP analyzes the μ, σ, γ, β parameters in the user's AI model and determines how to scale the parameters and where to set the decimal point for the values. The AI-CP then stores the parameters as 8 bit quantized and shifted values. Additionally, the value for μ is precalculated and stored as

$$\frac{- μ}{\sqrt{{σ}^{2} + ε}}$$

for easier use with me DSP slice. Similarly, the value for σ is precalculated to

$$\frac{1}{\sqrt{{σ}^{2} + ε}}$$

also for easier use with DSP slice. Alternate embodiments can (a) shift and/or quantize values differently, (b) store μ and σ in different formats, and/or (c) use different or no methods of precalculating.

Next, the AI-CP generates logic to handle the batch normalization operations. First, the AI-CP generates variables for μ, σ, γ, β that will be set to the current value of the variable. The AI-CP then connects the variables to the corresponding memory output signals for each variable.

After this, the AI-CP instantiates two DSP slices and connects the DSP slice inputs and outputs to the DSP slices. The AI-CP connects the incoming value, defined later, from the ROC to input one of the multiplier of DSP 1 and the μ variable to input two of the multiplier of DSP 1. The AI-CP then generates logic to shift the μ variable such that the decimal point is in the correct position to align with the result of the multiplication. If the values of μ, σ, or the ROC input have different decimal positions within the related variables for a layer, the AI-CP can generate logic to dynamically shift μ. Otherwise, the AI-CP generates a static shift and then connects the shifted μ variable to the accumulator input of DSP 1.

For DSP 2, the AI-CP first generates a series of ripple registers to track the values of γ and β across the delay of DSP 1. The AI-CP generates multiple ripple registers for both γ and β equal to the UoT delay of DSP 1. The AI-CP then connects the output of DSP 1 to input 1 of the multiplier of DSP 2 and connects the last ripple register for the γ variable to input 2 of the multiplier of DSP 2. The AI-CP then generates logic to shift the last ripple register for the β variable such that its decimal point aligns with the output of the multiplier of DSP 2. Similar to the shifting of the μ variable, the AI-CP determines if the last ripple register for the β variable needs to be shifted dynamically or if it can be statically shifted. The AI-CP then connects the shifted last ripple register for the β variable to the accumulator of DSP 2.

If the resources supplied to the AI-CP are limited and do not afford 2 DSP slices to be used for batch normalization, the AI-CP then utilizes a single DSP slice. In this case the AI-CP generates logic that reuses the DSP and generates logic to track the operations, the phase of the operations and multiplexers to select the correct DSP input at the correct moment.

Alternate embodiments can use more/fewer DSP slices or perform various shifting techniques. Also, alternate embodiments can avoid using DSP slices and instead use approximate multiplication through shifting operands.

Some embodiments also quantize the output of the BN to 8 bits. This can be accomplished by dynamically shifting the output of DSP 2 such that the result is within 8 bits and the decimal point is in the desires position. Alternate embodiments may not quantize the BN output, or might quantize the value differently.

Finally, the AI-CP generates counters or ripple registers to determine when the BN's output value is ready. The AI-CP determines how many UoTs are needed to produce the output value. The AI-CP generates: (a) one or more counters or ripple registers to track the needed UoTs until the BN output value is ready and (b) a ready signal. Once the counters or ripple registers have determined that output is ready, the BN module sends the current output value and an output ready signal to the next module in the ROC. Alternate embodiments can use other forms of logic to determine when an output value is ready such as a global counter or a signal from a DSP slice that signals when the computations have completed. Also, alternate embodiments might not send an output ready signal, but can instead determine that a value is ready through other logic such as: (a) a global counter or (b) the output value is not the maximum or minimum possible value.

Alternate embodiments may not use memory units; instead parameter values are received on a per filter basis or batch normalization parameters can be supplied to the BNs through commands or other methods. Alternate embodiments can also use this technique in conjunction with utilizing memory units.

### Pooler

The Pooler (P) modules implement the pooling functionality of CNNs. To generate the P modules the AI-CP first analyzes whether to select subcase NC1-p, NC2-p, NC3-p, or NC4-p. Then, the AI-CP analyzes the different pooling parameters within the module and the different types of pooling used. Once completed, the AI-CP generates the counters to track the number of values read to the P module, logic to calculate the pooling value, and logic to read out the pooling value.

First, the AI-CP determines whether to select subcase NC1-p, NC2-p, NC3-p, or NC4-p. For subcases NC1-p and NC2-p, the AI-CP only generates one P module. For subcases NC3-p and NC4-p, the AI-CP can generate more than one module, if resources permit.

Next, the AI-CP assigns pooling layers from the user's AI model to each P module. This results in each P module being assigned one or more pooling layers. For each P module, the AI-CP determines the set of pooling widths, pooling heights, and pooling types (minimum, maximum, average, etc.) that will need to be implement. The following process is performed for each P module to generate.

The AI-CP generates a counter (pooling counter) to track the number of values the P module has received. The width of the pooling counter is set so that it can hold a number of values equal to the largest pooling width*pooling height of the pooling layers assigned to the module. Next, the AI-CP generates logic such that the pooling counter counts up to the number of values to receive. If the height and width are the same for all pooling layers assigned to the module, the AI-CP generates a constant value up to which the pooling counter, counts. If there are only a few pooling height and pooling width combinations in the pooling layers assigned to the P module, the AI-CP will generate a few constants as well as logic to determine which constant to use for the given layer group that is being processed. And finally, if there are more than a few pooling height and pooling widths assigned to the P module, then the AI-CP generates a global parameter for the P module that will be set by a command that tells the P module the value up to which to count.

Next, the AI-CP generates logic to perform the functions of the pooling types (max, min, average, etc.) used by the pooling layers assigned to the P module. If all pooling layers assigned to the P module are the same pooling type, then only that pooling type will be generated. Otherwise, the AI-CP generates logic to implement each pooling type used by the pooling layers assigned to the P module, as well as logic to determine which value to use for the current layer group that is being processed. The AI-CP will also generate a variable (final value) to be sent to the next module within the ROC.

If the pooling layers assigned to the P module contain a pooling layer that uses maximum pooling, the AI-CP generates logic as now described. The AI-CP will generate a variable (max value) to track the maximum value of values read into the P module for a pooling group. The AI-CP will generate logic such that after each UoT if the P module has received a new incoming value, the max value is set to the maximum between the incoming value and the max value. This is the case for all incoming values received after the first incoming value is received within a pooling group. The AI-CP also generates logic that sets the max value to the incoming value for the first incoming value to be received within a pooling group. The AI-CP then generates logic to set final value to max value once all incoming values in a pooling group have been processed.

If the pooling layers assigned to the P module contain a pooling layer that uses minimum pooling, the AI-CP generates logic according to the same method as maximum pooling, except the variable (min value) is set to the minimum between the incoming value and the min value, when appropriate.

If the pooling layers assigned to the P module contain a pooling layer that uses average pooling, the AI-CP generates logic according to the following description. The AI-CP will generate a variable (sum value) to track the sum of values read into the P module. The AI-CP then generates logic such that after each Out, if the P module has received a new incoming value, the sum value is set to the sum of the incoming value and the sum value. This is the case for all incoming values received after the first incoming value received within a pooling group. The AI-CP then generates logic that sets the sum value to the incoming value for the first incoming value to be received within a pooling group.

Additionally, for average pooling, the user can select whether the AI-CP performs hardware friendly averaging, which by default is not selected. If hardware friendly averaging is not selected and there are enough resources for the AI-CP to instantiate a DSP slice, the AI-CP generates logic in accordance with the following. First, the AI-CP instantiates a DSP slice. The first factor input of the DSP slice is connected to the sum value. The second factor input of the DSP slice is connected as follows. If the pooling width*pooling height is the same for all pooling layers assigned to the P module, then the second factor input of the DSP slice is connected to

$$\frac{1}{pooling width * pooling height}$$

which is a known value calculated at compile time. If the pooling width*pooling height is different for pooling layers assigned to the P module, then the AI-CP calculates multiple known values, calculated at compile time, for each pooling width*pooling height combination and sets each known value to

$$\frac{1}{pooling width * pooling height}$$

respectively. The AI-CP then generates logic to determine the correct constant to connect to the second factor input of the DSP slice depending on the current layer group being processed. The AI-CP then generates logic and counters to track DSP slice propagation and sets the final value to the output of the DSP slice once all incoming values in a pooling group have been processed and the values have propagated through the DSP slice.

Instead, if hardware friendly averaging is selected or there are not enough resources for the AI-CP to instantiate a DSP slice, the AI-CP will generate logic as follows. Once sum value has added all incoming values within a pooling group, the sum value will be shifted instead of multiplied by a reciprocal. If the pooling width*pooling height is the same for all pooling layers assigned to the P module, then the AI-CP will generate logic to set a final value as follows:

final value=sum value>>└log₂(pooling width*pooling height)┘ Eq. 13

If there are different pooling width and pooling height combinations within the pooling layers assigned to the P module, then the AI-CP will generate shift logic for each pooling width and pooling height combination as previously stated and generate logic to set final value to the correct shift value depending on the current layer group being processed. Alternate embodiments can also set the shift value using the ceiling or round function as opposed to the floor function in Eq. 13. Alternate embodiments can also give users the option to select the floor, ceiling, or round function and can also apply different selections on a per layer basis.

Finally, the AI-CP generates logic to read out a final value. The AI-CP generates an output port for final value and a final value ready signal. Then, the AI-CP generates logic to set the final value ready signal to ready once each incoming value for a pooling group has been processed and whether values have propagated through the DSP slice, if appropriate.

### Skip Connector

The Skip Connector (SC) modules implement the skip layer functionality of CNNs, also known as addition layers or residual layers. To generate the SC modules, the AI-CP first analyzes whether to select subcase NC1-sc, NC2-sc, NC3-sc, or NC4-sc. Then, the AI-CP instantiates the memory units for each SC module, as well as logic to read and write from the memory units. After this, the AI-CP generates the input ports and logic to select the incoming value. Next, the AI-CP generates adders to sum together the incoming values with the values from memory. Finally, the AI-CP generates logic to send the summed value to the next module in the ROC.

First, the AI-CP determines whether the user's AI model follows subcase NC1-sc, NC2-sc, NC3-sc, or NC4-sc. For subcases NC1-sc and NC2-sc, the AI-CP will only generate a single SC module. For subcases NC3-sc and NC4-sc (NC3,4-sc), the AI-CP can generate more than one SC module. For NC3-sc and NC4-sc, the AI-CP will determine if there are adequate resources to instantiate multiple SC modules. If there is not, the AI-CP will generate a single SC module, as well as generating logic to schedule and reuse the single SC module.

Next, the AI-CP instantiates the memory units in each SC module. For each SC module, the AI-CP determines if there are enough resources to instantiate two memory units. By instantiating two memory units, the SC module can buffer additional previous layer data to reduce, and likely eliminate, delayed processing due to the external memory bandwidth. If there are not enough resources to instantiate two memory units in each of the SC modules, the AI-CP will instantiate two memory units in SC modules when possible, starting with the SC modules that will be used most, and will instantiate one memory unit in all other SC modules. Alternate embodiments can use more/fewer memory units. An alternate embodiment can use more memory units to buffer more data or perform multiple skip connections at once. An alternate embodiment can also perform multiple skip connections regardless of the number of memory units. Finally, an alternate embodiment can use no memory elements, but receive the previous layer data once it is ready to be summed with the current layer output.

Next, the AI-CP generates logic to write data into the instantiated memory units for each SC module. The AI-CP generates ports for the incoming previous layer data and previous layer metadata including the x and y position of the previous layer data. The AI-CP then generates logic to take the incoming data and write it to the correct location in a memory unit. If the SC module has multiple memory units, the AI-CP generates logic to select which memory unit to store the incoming previous layer data.

Then, the AI-CP generates logic to read data from the instantiated memory units. The AI-CP generates logic such that once the SC module receives an incoming value from the ROC, the generated logic reads the data from the memory unit that corresponds to the x,y location of the received incoming value. If the SC module has multiple memory units, the AI-CP generates logic to select from which memory unit to read.

After this, the AI-CP generates logic to perform the additive component of the skip layer and read out the result to the next module in the ROC. The AI-CP generates logic to sum together the incoming value and data read out from the instantiated memories. The summed value is referred to as the final value. Finally, the AI-CP generates logic to read out the final value. The AI-CP generates an output port for final value and a final value ready signal. Then, the AI-CP generates logic to set the final value ready signal to ready once an incoming value has been added to the value read from the instantiated memory.

### Incoming Connections

For each BN, P, and SC module generated, the AI-CP must configure the inputs to the modules which will determine which incoming value to use for the current layer group. The following discussion demonstrates how the AI-CP configures the inputs based on the subcases of NC #-bn, NC #-p, and NC #-sc. For the following, we will use the notation NC #-x, where the −x represent it is being applied for the respective module type. Additionally, X is used to represent either BN, P, or SC. Therefore, NC #-x/X will represent and be applied to all NC #-bn /BN, NC #-p/P, and NC #-sc/SC. The AI-CP then does the following for all BN, P, and SC modules. For each case the AI-CP determines and generates the needed ports as well as connects and generates logic to determine the current port to select as the incoming value.

In case NC1-x, the X will only be instantiated once, and its input value will only be connected to the output of one module within the ROC. For this, the AI-CP will generate one input port set and connect the input port set directly to the input value set. We refer to a port set or value set to include all inputs or outputs that are associated with a single input or output. For example, some embodiments will provide a value and a ready signal as the port set. Alternate embodiments can use greater or fewer ports within a port set. The AI-CP will also generate one output port set within X. The AI-CP will later connect the input port set of the instantiated X module to the corresponding output port set of its source module within the ROC or to the scheduling logic as appropriate.

In case NC2-x the X will also only be instantiated once, and its input value will need to be multiplexed between different input port sets. For each layer type that precedes X in the user's module, the AI-CP generates an input port set in X. The AI-CP then generates multiplexers and logic that determine which input port set to select as the incoming value depending upon which layer group of the user's AI model is currently being processed. The input to select will be noted in the AI-CP's created schedule. The AI-CP will also generate one output port set within X. The AI-CP will later connect each input port set of the instantiated X module to the corresponding output port set of modules within the ROC or to the scheduling logic as appropriate.

In the case of NC3-x, the AI-CP will follow the same process to generate the X as in NC1-x and will only generate one X module. The AI-CP can instantiate the X module more than once if it determines that there are sufficient resources to instantiate more than one X module. If fewer X modules are instantiated than the maximum number of X modules in all series of non-convolutional layers, the AI-CP will generate additional scheduling logic to reuse at least one or more instantiated X modules while processing data in the ROC. The AI-CP will also generate one output port set within X. The AI-CP will later connect the input port set of each instantiated X module to the corresponding port sets of modules within the ROC or to the scheduling logic as appropriate.

In the case of NC4-x, the AI-CP will possibly generate multiple X modules and the input connections to the X modules within the ROC will vary. The AI-CP generates an X module for each unique combination of possible incoming sources. If there are more than one unique combinations, the AI-CP will begin by copying all chip design elements already generated within the X module for each X module to be generated. For each generated X module, the AI-CP generates logic to determine the correct incoming source to choose based on the current layer group being processed. The input to select will be noted in the AI-CP's created schedule. In the NC4-x case, there can be some X modules generated that only have one incoming source and hence the AI-CP does not generate logic to select the incoming source for these X modules. The AI-CP will also generate one output port set within X. The AI-CP will later connect the input ports of each instantiated X module to the corresponding ports of modules within the ROC or to the scheduling logic as appropriate.

### Data Formatter

The Data Formatter (DF) reads layer input data from either memory, external memory, or the input data source and sends data and metadata to cores and other modules. To generate the DF, the AI-CP generates the data and metadata buses, logic to interpret incoming data and populate the data and metadata buses, and logic to send NN weights to each core.

First, the AI-CP generates the data and metadata buses. In some embodiments, the AI-CP generates three parallel buses that have multiple receivers and are only written to by the DF. The first parallel bus (data bus) transmits the data values for the current position within the input data. The second parallel bus (x-bus) transmits the x location metadata for the current position within the input data. And the third parallel bus (y-bus) transmits the y location metadata for the current position within the input data. The AI-CP sets the width of the data bus to ┌log₂(max (input value range))┐. Similarly, the AI-CP sets the width of the x-bus to ┌log₂(max (input layer widths))┐. And similarly, the AI-CP sets the width of the y-bus to ┌log₂(max (input layer heights))┐. Each of these values considers the width and height after applying padding, upsampling, and deconvolution. The AI-CP will later use ADE to connect the data bus, x-bus, and y-bus to each receiving instantiated module.

Once the buses are generated, the AI-CP generates logic to populate the buses. The AI-CP generates logic to populate the buses for both convolution-based operations and NN based operations. The AI-CP also generates logic to determine whether to use data from the Source/Data Inputs, the EMR or internal memory as the incoming data.

For convolution-based operations, the AI-CP generates logic to track the x and y locations of the incoming data. First, the AI-CP generates two global registers within the MC that are populated with the current input layer's width (x-max) and height (y-max), respectively. The AI-CP later connects the global registers to the DF using ADE. The AI-CP then generates two counters to track the x and y location within the current input layer, the x-counter and y-counter, respectively. Some embodiments read input data in the following order, width, height, and depth, and which correspond to the x, y, and specific layer dimensions. The AI-CP generates counter logic in accordance with the following. The x-counter is incremented each time a new input value is received. Once the x-counter reaches x-max, the x-counter is reset and the y-counter is incremented. Furthermore, once an entire layer of input data is written to the data bus, both the x-counter and y-counter are reset. The AI-CP then generates logic such that when new incoming data is received in the DF, the logic will set the x-bus to the current x-counter value, the y-bus to the current y-counter value, and the data bus to the incoming data.

In addition to sending data to the entire generated design by populating the x-bus, y-bus, and data bus, the DF also implements padding and upsampling, and supports deconvolutions. For each of these, the AI-CP modifies how it generates the logic that sets the x-bus, y-bus, and data bus. Additionally, if these features are not used in the user's AI model, then the following modifications are not generated.

First, as described above, the AI-CP also generates logic to implement padding. The AI-CP generates additional global registers to hold the current padding dimensions. If all padding dimensions within the same layer of an input layer are the same in the x and y dimensions, the AI-CP generates one global padding register. Otherwise, the AI-CP generates two global registers, an x-padding register and a y-padding register. The following discussion refers to the x-padding and y-padding registers. In the case that only a single padding register is generated, this single register is used for both.

To implement padding, the AI-CP generates logic according to the following. If there are layer groups that do not use padding, the AI-CP generates logic to use the following only if the current layer group uses padding. The values stored in the x-max and y-max global registers are increased by 2*x-padding and 2*y-padding, respectively, at compile time. Then, the AI-CP generates additional logic to alter how the data bus is set. The newly generated logic sets the data bus to the padding value, most commonly 0, when either the x-counter is within the area of x-padding to the left or right of the input layer or the y-counter is within the area of y-padding to the top or bottom of the input layer. Furthermore, the AI-CP alters the generated logic such that the generated logic sets the data bus to the incoming data only when the x-counter and y-counter are within the non-padded region of the input layer.

Next, how the AI-CP generates logic to implement upsampling is described. The AI-CP generates additional global registers to hold the current upsampling dimensions. If all upsampling dimensions within the same layer of an input layer are the same in the x and y dimensions, the AI-CP generates one global upsampling register. Otherwise, the AI-CP generates two global registers, an x-upsampling register and a y-upsampling register. The following discussion refers to the x-upsampling and y-upsampling registers. In the case that only a single upsampling register is generated, this single register is used for both.

To implement upsampling, the AI-CP generates logic in accordance with the following. If there are layer groups that do not use upsampling, the AI-CP generates logic to use the following only if the current layer group uses upsampling. The values stored in the x-max and y-max global registers are multiplied by x-upsampling and y-upsampling at compile time. Then, the AI-CP generates two additional counters, an x-counter-US and y-counter-US. The AI-CP generates logic to increment the x-counter-US in each UoT after a new incoming value is received until x-counter-US reaches x-upsampling. Once x-counter-US reaches x-upsampling, x-counter-US is reset and will continue to be incremented in each UoT. This continues until x-counter-US reaches x-upsampling and y-counter-US reaches y-upsampling. The AI-CP also generates logic to increment y-counter-US each time x-counter-US reaches x-upsampling until y-counter-US reaches y-upsampling. Then, the AI-CP generates additional logic to alter how the x-counter, y-counter, x-bus, y-bus, and data bus are set. The AI-CP generates logic such that the x-counter and y-counter are incremented only when both x-counter-US reaches x-upsampling and y-counter-US reaches y-upsampling. When this happens, if x-counter is less than x-max minus x-upsampling, then x-counter is incremented by x-upsampling and y-counter is not incremented. If x-counter is greater than or equal to x-max minus x-upsampling, then x-counter is reset and y-counter is incremented by y-upsampling. The AI-CP also generates logic such that each time a new incoming value is received the data bus is set to the received incoming value and x-bus is set to x-counter plus x-upsampling and y-bus is set to y-counter plus y-upsampling until x-counter-US reaches x-upsampling and y-counter-US reaches y-upsampling.

Next, how the AI-CP generates logic to implement deconvolution is described. The AI-CP generates additional global registers to hold the current deconvolution dimensions. If all deconvolution dimensions within the same layer of an input layer are the same in the x and y dimensions, the AI-CP generates one global deconvolution register. Otherwise, the AI-CP generates two global registers, an x-deconvolution register and a y-deconvolution register. The following discussion refers to the x-deconvolution and y-deconvolution registers. In the case that only a single deconvolution register is generated, this single register is used for both.

To implement deconvolution, the AI-CP generates logic as follows. If there are layer groups that do not use deconvolution, the AI-CP generates logic to use the following only if the current layer group uses deconvolution. The values stored in the x-max and y-max global registers are multiplied by x-deconvolution and y-deconvolution at compile time. Then, the AI-CP generates two additional counters, an x-counter-D and y-counter-D. The AI-CP generates logic to increment x-counter-D for each UoT after a new incoming value is received and until x-counter-D reaches x-deconvolution. Once x-counter-D reaches x-deconvolution, x-counter-D is reset and will continue to be incremented each UoT. This continues until x-counter-D reaches x-deconvolution and y-counter-D reaches y-deconvolution. The AI-CP also generates logic to increment y-counter-D each time x-counter-D reaches x-deconvolution until y-counter-D reaches y-deconvolution. Then, the AI-CP generates additional logic to alter how the x-counter, y-counter, x-bus, y-bus, and data bus are set. The AI-CP generates logic such that the x-counter and y-counter are incremented only when both x-counter-D reaches x-deconvolution and y-counter-D reaches y-deconvolution. When this happens, if x-counter is less than x-max minus x-deconvolution, then x-counter is incremented by x-deconvolution and y-counter is not incremented. If x-counter is greater than or equal to x-max minus x-deconvolution, then x-counter is reset and y-counter is incremented by y-deconvolution. The AI-CP also generates a register to hold the value of incoming values, called deconvolution input value. The AI-CP generates logic such that when the AI-CP receives a new incoming value, the deconvolution input value is set to the received incoming value. The AI-CP also generates logic such that x-bus is set to x-counter plus x-deconvolution and y-bus is set to y-counter plus y-deconvolution until x-counter-US reaches x-deconvolution and y-counter-US reaches y-deconvolution. The AI-CP also generates logic to set the data bus to the deconvolution input value when x-counter-D is equal to x-deconvolution divided by 2 minus 1 and y-counter-D is equal to y-deconvolution divided by 2 minus 1; the AI-CP generates logic to perform these calculations by right shifting these values by 1. The AI-CP generates logic to set the data bus to the deconvolution value, which is typically 0, but the user's AI model can specify otherwise, when x-counter-D does not equal x-deconvolution divided by 2 minus 1 or y-counter-D does not equal y-deconvolution divided by 2 minus 1. If the user's AI model has multiple values for the deconvolution value, the AI-CP generates logic to determine which value to use for the deconvolution value for the current layer group.

Finally, the AI-CP generates logic for distributing the NN weights and input node values. The AI-CP generates a connection between each core and the DF. To do this, the AI-CP generates an input port in each core and an output port in the DF for each core. Then, the AI-CP generates a variable for each core within the DF that will hold the value of the NN weights for the core to use. Next, the AI-CP determines the number of weights that can be read from either external or internal memory during each UoT. The AI-CP then generates logic and connections to divide the incoming weight values into the variables for each core's weights. The AI-CP will store the weights according to the AI-CP's created schedule such that the correct weights will be sent to the correct cores during each UoT. The AI-CP will then generate logic to set data bus, x-bus, and y-bus. The AI-CP generates logic to set data bus to the value of the input node the cores should multiply the weights by. Next, the AI-CP generates logic to set x-bus to the position of the input node. Then, the AI-CP generates logic to set y-bus to 1. Lastly, the AI-CP generates multiplexers and control logic to set the data bus, x-bus, and y-bus as described during NN operations and as previously noted during convolution operations.

Alternate embodiments can buffer incoming data using memory units or other structures. In the alternate embodiments, the AI-CP can load data into memory units, or other structures, so that they can be recalled multiple times. Another possibility for the use of buffering is that the type of external memory can require paging and the DF may need to read large portions of external memory at once.

### External Memory Controller, Reader, and Writer

Each of the External Memory Controller (EMC), External Memory Reader (EMR), and External Memory Writer (EMW) select, read from, and write to external memory units. The AI-CP can generate logic for a variable number of external memory units set by either the user or the stated hardware design. In the following description, external memory units are referred to simply as memory units concerning the External Memory Controller, Reader, and Writer.

For the EMC, the AI-CP generates logic to select the current reading and writing memory units. The AI-CP generates logic to receive commands or global registers from the MC specifying which memory unit the EMR will read from and to which memory unit the EMW will write. The AI-CP generates connections to the EMR and EMW to identify which memory units, and therefore which memory interfaces are active for the respective modules. Alternate embodiments can use commands, signals, and/or generate logic to determine which external memory banks to use for reading and writing, to and from. Furthermore, alternate embodiments can use fewer external memory units. For alternate embodiments with zero external memory units, the EMC would notify the EMR and EMW which internal memory banks to address. Additionally, for an alternate embodiment with only one external memory unit, the EMC will only allow one action to happen during any UoT between the EMR and EMW. The EMR and EMW cannot read from or write to the memory unit at the same time. The AI-CP will accomplish this through generating such logic within the EMC, as well as the AI-CP's created schedule which includes reading and writing activities. Furthermore, for alternate embodiments with one external memory unit, the alternate embodiment can specify a priority between reading from and writing to the memory unit.

For the EMR, the AI-CP generates logic to read from external memory units. For each memory unit the AI-CP generates variables for the memory unit's interface. For each unique memory unit interface type, the AI-CP generates logic to implement the memory unit's communication protocol to read from the memory unit. Additionally, if multiple memory units can be read from simultaneously, the AI-CP generates logic to implement additional, potentially duplicate, memory interface protocols such that each possible combination in the created schedule is accounted for. Finally, the AI-CP generates logic for each set of memory interface variables such that the set is set to an inactive signal, often held low, if the set is not selected as active by the EMC, as well as logic that sets the set to the correct incoming read signals from other modules if the set is selected as active by the EMC.

Furthermore, the generated chip implements the CNN feature of reshaping within the EMR. The EMR implements reshaping by altering the method in which data is read in. The AI-CP analyzes the user's AI model and generates the read in logic differently if the user's AI model has reshaping layers present. First, the AI-CP generates two additional global registers, x-reshape and y-reshape, which hold the reshaping dimensions for the current layer group. The AI-CP then generates the read in logic such that at each step of reading in data, the generated logic advances the address equal to x-reshape or y-reshape as appropriate and begins the next reshaped layer at the correct address.

For the EMR, the AI-CP generates a number of global registers proportionate to the number of memory read interfaces that can be active simultaneously, and that specify the read address start, the number of addresses to read and the number of layers to read when appropriate for each active memory read interface. The AI-CP also generates an input port in the EMR for each memory read interface that can be simultaneously active to receive a signal to begin reading in data.

For the EMW, the AI-CP generates logic to write to external memory units. For each memory unit, the AI-CP generates variables for the memory unit's interface. For each unique memory unit interface type, the AI-CP generates logic to implement the memory unit's communication protocol to write to the memory unit. Additionally, if multiple memory units can be written to simultaneously, the AI-CP generates logic to implement additional, potentially duplicate, memory interface protocols such that each possible combination in the created schedule can be accounted for. The AI-CP generates logic for each set of memory interface variables such that the set is set to an inactive signal, often held low, if the set is not selected as active by the EMC. The AI-CP also generates logic that sets the set to the correct write signals from other modules if the set is selected as active by the EMC.

For the EMW, the AI-CP generates a number of global registers, proportionate to the number of memory write interfaces that can be simultaneously active, and specifies the write address start and number of addresses to write for each active memory write interface. The AI-CP also generates logic that determines when to write data to external memory based on when data is received by the EMW.

Additionally, the generated chip implements CNN concatenation through the EMR and EMW. The AI-CP implements CNN concatenation by (a) first, writing filter outputs that will be concatenated to selected memory locations and (b) second, reading in these selected memory locations such that the data, which is the filter outputs to concatenate, is read in, in the order of the concatenated filter outputs. This is implemented in the created schedule by setting the read address start, number of addresses to read, number of layers to read, write address start, and number of addresses to write global registers to the appropriate values.

Alternate embodiments of the EMR and EMW can include performing decryption and encryption operations. Alternate embodiments can store commands, data values, calculated values and the like. in an encrypted format. In alternate embodiments, the EMW can perform the encryption before writing data to either external or internal memory. Alternate embodiments can also have the EMR perform decryption after reading data. Still further, alternate embodiments can also (a) encrypt commands, but not data or (b) encrypt data, but not commands.

### Master Controller

The Master Controller (MC) coordinates all activities within the generated chip. This includes interpreting commands, setting global registers, sending parameters, scheduling read and write operations, beginning processing operations, paging in data and using finite state machine and timers to coordinate activities.

First, the AI-CP generates input ports, output ports, and variables for the command and data buses and signals. Some embodiments use a single bus and signal for commands and data. Alternate embodiments can use multiple buses and signals. The AI-CP also generates input ports for the command and data buses and signals in each module receiving the command and data buses and signals.

Next, in some embodiments, the AI-CP generates each global register within the MC. Alternate embodiments can generate the registers at different places within the generated chip. Previously, generated modules have generated global registers, all of which the AI-CP now generates within the MC. Each global register will be routed to the needed instantiated modules during module instantiation.

The AI-CP also interprets commands read in from the external memory. The AI-CP creates a schedule, translates the schedule into commands, and stores the commands in memory. If the commands and data to be processed cannot be stored on the chip, the commands are allocated to external memory and read in through the EMR. The generated chip retrieves the commands, interprets them, and performs the required actions. For each global register, the AI-CP generates logic that sets the register if a processed command dictates it be set and determines the appropriate value to which the register is set. The AI-CP also generates logic to set the command and data buses according to the commands received. Some values are interpreted and set into global registers while other values are interpreted and set onto the command and data buses.

Additionally, the MC implements finite state machines (FSMs) to determine when to start and stop different operations. This includes: (a) an FSM that determines when to read from external or internal memory, (b) an FSM to determine when to write to external or internal memory, (c) an FSM to start convolution or NN operations, (d) an FSM to set parameters and values within a core, and (e) an FSM to begin streaming NN weights. The AI-CP generates variables, registers, counters, and logic to track the state of each FSM, the amount of time to execute operations and the amount of time to wait before the next operations. The AI-CP generates logic to implement each of these FSMs. The AI-CP also generates logic to set the different variables and registers based on the commands received and interpreted. Alternate embodiments can use more or fewer FSMs and can combine one or more FSMs into a single FSM.

The AI-CP also generates logic within the MC that starts convolution and NN operations. The AI-CP generates logic that implements the created schedule's instructions for the MC to set parameters and signals that correspond to starting such operations. The AI-CP generates logic such that when these commands are received, the MC signals to each core when to begin an operation and what type of operation to begin.

Furthermore, in some embodiments, the AI-CP generates logic and instantiates memory units to buffer command information, parameters values, and operation instructions. The AI-CP creates a schedule to read in commands and data from external or internal memory and generates logic to store the uninterpreted commands and data in the MC's instantiated memories. The AI-CP then generates logic to read from the instantiated memories and interpret and execute the commands.

### Module Instantiation

Once the AI-CP has generated each module, the AI-CP generates a top level module, referred to as System, and instantiates the appropriate modules within System. First, the AI-CP will instantiate shell modules within System for each of the appropriate generated modules other than the HCMs and the modules that will be contained in the Following Layers. A shell module is a module that has only been named, but does not have any inputs, outputs, or logic defined in the module. Below, an example shell module is shown and an example shell module instantiation is shown below that. The examples do not show parameterized modules which can also be shell modules. Some embodiments will generate modules in the form of HDL, while other embodiments make use of other forms of chip design components.
module ShellModule( );
endmodule
------------------------------------------------------------------------------------------
ShellModule shellModule( );

The AI-CP then generates a shell module called Cores and instantiates all cores using their respective HCMs within Cores. Each core has specified C_{DM}, C_{MM}, and C_{DSP} values that match one of the generated HCMs. For each of the C cores, the corresponding HCM is located and instantiated in the Cores module. Each HCM is also assigned a core address used for communication. In some embodiments, the core address is a parameter assigned using the #( ) notation in the module instantiation, as well as an ADE property.

Once each HCM is instantiated, each HCM's inputs and outputs are connected to the corresponding shell modules. When a connection is made to a shell module, ADE generates the appropriate inputs or outputs within the module, ADE adds the inputs or outputs to the instantiated shell module and ADE routes the connection to or from the shell module to instantiated HCM. Each HCM connects its inputs as follows: (a) the command bus and signals, global registers, and read requests inputs of each core are connected to the MC; (b) the data and metadata bus inputs of each core are connected to the DF; and (c) the data output and read out signals of each core are connected to the ROC.

The AI-CP then generates a new module Following Layers and instantiates each BN, P, and SC module that was determined to be needed within the Following Layers. The AI-CP also generates variables to connect the instantiated BN, P, and SC modules within the Following Layers and connects the generated variable to the input and output ports of the instantiated BN, P, and SC modules as pertains to the AI-CP's determined order. The AI-CP then generates a new module Read Out Chain and instantiates the DOC, AF, and Following Layers modules within the Read Out Chain.

The AI-CP then generates all input and output ports for System so that it can interface with external memory units, the data source, and the output of the generated chip. Next, the AI-CP uses ADE to connect all components within the System module, including the MC, DF, Cores, Read Out Chain, EMR, EMW, and EMC.

Additionally, depending on the read out width or bandwidth of the external memory, the generated chip design can have the capability to read out multiple intermediate and final values, simultaneously. If n values are read out simultaneously, the AI-CP generates multiple ROCs. The AI-CP determines how many resources can be allocated for multiple ROCs and then instantiates between one and n ROCs. The resource determination is made early in the AI-CPs process before the resources available for cores are determined. If the AI-CP instantiates multiple ROCs, the connections, schedule, and processing are altered to support multiple ROCs.

### Alternate Embodiments

According to the presently disclosed technology, design of the generated chip and its organization can be accomplished through different embodiments; all of which utilize substantially the same approach and principles. The disclosed technology detailed thus far includes: (a) a design environment that accelerates the chip design process by allowing developers to write algorithms that develop the chip design; (b) a multiple buffering core that performs convolutions and NN operations; and (c) generating and instantiating chip design components such that the resulting generated chip design implements the functionality of a user's trained AI model.

Alternate embodiments include accelerated design environments that are not implemented in software. Some embodiments implement ADE through matching an attribute tag and implementing an attribute algorithm in software. Alternate embodiments can implement the attribute algorithms through other means such as manually, hardware-based processing or any means that executes the algorithm.

Additionally, an alternate embodiment of the chip generation can be performed using tools other than ADE or other embodiments of ADE than those thus described. Additionally, alternate embodiments of the chip generation may not use any accelerated development environment. Such embodiments can generate the chip design, add all components where they need to be, create the needed import and output ports on modules, and the like. Also, such alternate embodiments can generate some, or all, of the chip design without the use of a design environment capable of parsing the design and making the needed edits.

Through the use of ADE, or an alternate embodiment of ADE, the location, organization, and structure of the resulting generated chip design is not essential to the embodiment. ADE enables connections and routing to be easily made. Because of this, the location, organization and structure of the chip design can be drastically different in alternate embodiments. Such alternate embodiments: (a) may not have separate EMR, EMW, and EMC modules; (b) can have combined MC and DF modules; (c) can combine all cores into a single module and/or (d) can combine or disperse modules within the ROC. Furthermore, alternate embodiments can embed some of the functionality of the ROC within the cores or within the EMW. Due to the use of ADE, alternate embodiments can exist that have any structure such that they are generated, partly generated, or created manually, and implement the calculations to perform the inference for a user's trained AI model.

Alternate embodiments include chip design creation that includes one or more components of the chip design as disclosed, while other embodiments are not required to contain all of the components that are described. Still further, embodiments using a single component are also contemplated by the present disclosure.

Alternate embodiments can perform different resource allocation techniques. Alternate embodiments can consider some components more in need of resources. Additionally, other alternate embodiments may not perform resource allocation, but instead use a static resource allocation.

Alternate embodiments include chip designs that reuse processing elements. Some embodiments allocate resources that include memory units and DSP slices or MAC units to specific functions or units. Other embodiments generate chip designs that reuse components for different computations and can generate logic to determine the appropriate inputs to a resource given the state of the computation.

Alternate embodiments can use different processing elements as opposed to the described multiple buffering core. Different processing cores can also be used, but which incorporate the core into a generated chip.

Alternate embodiments can also store data in a single location as opposed to the data memories dispersed throughout the cores. In these alternate embodiments, data is read into the generated chip design and is stored in one or more central memory units. The memory unit(s) are then read out and broadcast their values to whatever processing sources that embodiment instantiates. Multiple buffering on input data is also contemplated.

Alternate embodiments can also generate the chip design such that memory and processing are not allocated into a distinguishable core. Following the process of generating the chip design, alternate embodiments can generate and instantiate memory units together, and DSP or MAC units together. Using ADE, or an alternative to ADE, such alternate embodiments can then connect the memory units and DSP or MAC units together in such a way to implement the needed convolution or NN operations.

Alternate embodiments can also include some, or all of the disclosed processing elements. Not all AI models utilize each CNN or NN feature discussed. Alternate embodiments that support only a subset of the operations are also contemplated by this disclosure. Such alternate embodiments can also include implementations that include only operations found within the convolution portion of a CNN or include only operations found within the NN portion.

Alternate embodiments can also add common chip design components to the generated chip that were not discussed. This includes common peripherals, memory interfaces, video or image inputs and outputs, or any other communication protocol and associated chip design components.

Alternate embodiments can also store internally data and commands that other embodiments store in external memory. Some chip designs will target resources that are sufficient to store some or all values in internal memory units, while other embodiments store them in external memory.

Alternate embodiments also include chip designs where some portion of the chip design is performed manually. Some embodiments generate the entire chip design. However, alternate embodiments can have some portion, or most, of the chip design done manually and then add to the manual chip design generated components. Furthermore, a fully manual chip design that implements some embodiments is an alternate embodiment contained in this disclosure.

Alternate embodiments also include generating or manually creating one or more components of the chip design. Some embodiments generate all the stated components. Some embodiments can generate fewer components and it is contemplated that other embodiments can create only some of the components that are herein described.

Alternate embodiments also include chip designs that perform any of the CNN computations, including but not limited to convolution, NN, batch normalization, pooling, padding, stride, concatenation, upsampling, deconvolution, activation functions, and the like, through different computation methods. Such alternatives can implement convolution through a different order of processing data, NN operations that change the order of how computations are processed, applying padding within a core or other processing unit, performing pooling while reading data in from memory, etc. Alternate embodiments that create functionally the same logic are included in this disclosure.

Alternate embodiments also include generating chip design components for features not discussed in the disclosure. AI models, and CNNs in particular, support a wide array of features. This disclosure specifies the implementation of many key features of CNNs, but alternate embodiments that include CNN features that not discussed, but follow similar methods for generating the chip design, are also considered within the scope of the presently disclosed technology.

Additionally, alternate embodiments include activation functions not discussed specifically in this disclosure. It is well known how to implement particular functions within a chip design. This disclosure includes generating activation functions, including those not specified, when generated in a similar manner.

### Schedule Generation

Once the AI-CP has determined the values of C, C_{DM}, C_{MM}, and C_{DSP} and has generated and instantiated the chip design components, the AI-CP creates a computation and memory management schedule to implement the CNN and NN computations. The items within the AI-CP's schedule are referred to as events which include setting register values, assigning filters to cores, and reading from or writing to memory or external memory. The AI-CP creates events in the schedule as they pertain to layer groups and slices. A slice is a group of events to be processed together and distributed amongst the cores and other modules such that the processing of a slice occurs without needing to read new data into data memories.

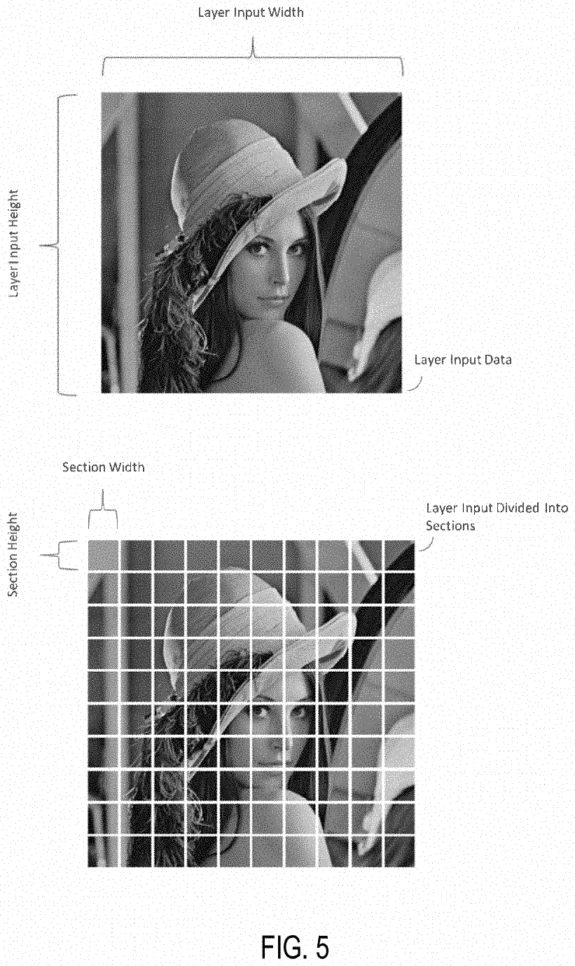

First, the AI-CP divides the convolution input of a layer group into sections to be processed. This process will be performed for each layer group in the user's AI model. To do this, the AI-CP determines the section width (sw) and section height (sh) of a section. An example of an input layer divided into sections is shown in FIG. 5. Some embodiments utilize cores with memory units of the same size; however, alternate embodiments can adjust the schedule creation to account for cores with varying size memory units. To determine sw and sh the AI-CP determines how to divide the input layer such that the resulting number of core assignments is minimized and therefore the processing time is minimized. Furthermore, some embodiments only determine possible widths such that sw is a positive integral divisor of the convolution layer's input to simplify the generated design; however, alternate embodiments may not utilize this requirement. To determine sw and sh, the AI-CP must use the filter width (fw) and filter height (fh) for the filters within the convolution layer. If the convolution layer is an inception layer, the AI-CP performs this process with the largest filter and the data memories alter their read out patterns, if applicable. In the following procedure, the dimensions of the convolution input include any padding, upsampling, or deconvolution operations and are referred to as the convolution input width (cw), convolution input height (ch), and convolution input layer count (cl). Additionally, the number of memory addresses in a data memory, or data memory size, is referred to as dms.

The AI-CP then determines sw and sh as follows: the AI-CP begins by setting sw to 1 and setting sh to

$$⌊ \frac{dms - ( fh - 1 ) * ( s w + f w - 1 )}{s w + f w - 1} ⌋ .$$

The number of core assignments is then determined to be

$$⌈ \frac{c w * c h * c l}{s w * s h} ⌉ .$$

Then sw is incremented to the next positive integral divisor of cw. This process is then repeated until sw has been set to each positive integral divisor of cw. Additionally, if the layer group contains pooling, the AI-CP requires that the selected values of sw and sh are multiples of the pooling width and pooling height respectively. The AI-CP selects the combination of sw and sh that produces the smallest number of core assignments. The final row of sections within the convolution input can have a section height less than sh due to sh not being a positive integral divisor of ch. Alternate embodiments can use other methods to determine the sw and sh, which can be as large as the entire input. Other embodiments can determine sw and sh manually or statically.

Next, the AI-CP determines how many cores to use for convolution operations and how many cores to use for NN operations during each slice. The AI-CP's schedule is created such that there is overlap between convolution and NN operations to increase throughput. The AI-CP uses the number of memory inputs, the number of NN operations to perform, the number of input layers and the number of filters to determine how many cores to use for NN operations. Additionally, the AI-CP calculates the number of UoTs that will be needed for NN operations and how many slices will overlap NN operations. From this, the AI-CP determines for each slice (a) the number of cores, and (b) which cores are available for convolution operations (C_{conv}). Since the NN operations typically are performed at the end of a CNN, the overlap between NN operations and convolution operations occur with the first layer, possibly layers, of convolution layer groups. The initial convolution layer groups typically have fewer layers and fewer filters which lend their use for better overlap with NN operations. Alternate embodiments might not overlap NN operations with convolution operations. Other embodiments can process NN operations outside of the cores and may or may not overlap NN operations with convolution operations.

Once sw and sh have been set for layer groups, and C_{conv} has been set for slices, the AI-CP creates core assignments for each core of each slice. Core assignments include the section of the convolution input that the core will process, and the filters that will be assigned to the core during this slice. The sections are assigned to a core in terms of the section's starting x-coordinate (start-x) and the section's starting y-coordinate (start-y). Furthermore, the AI-CP assigns to a core, a section for each data memory the core possesses.

The AI-CP assigns sections according to the following procedure. The AI-CP assigns sections of the convolution input from left to right then top to bottom. Viewing the convolution input as two dimensions, ignoring the layers within the input, the AI-CP begins in the top left of the input as it assigns sections, and then moves from left to right without changing the start-y. Once the AI-CP reaches the far right of the convolution input, the AI-CP proceeds by incrementing the start-y to the next row of the convolution input and starts with the left most section of the convolution input. As this is being performed, the AI-CP assigns different layers of the same section to multiple cores to be processed at the same time. The following uses the notation section-layer to refer to an input layer within a section. The AI-CP will start with the first section-layer of the slice; either the first section-layer of the convolution input or the next section-layer after the most recently assigned section-layer, and assigns the section-layer to the first data memory in the first core. The AI-CP then assigns layers within the same section to the first data memory of successive cores until either all section-layers within the section have been assigned, or all of the first data memories for all cores have been assigned. The AI-CP then assigns section-layers for the next section to the second data memory of each core in the same manner. This process is repeated until the AI-CP has assigned a section-layer to each data memory of the first core and has followed the previous process. Once this is completed, there can be data memories that have not been assigned a section-layer. The AI-CP will continue this process, starting with the first core that has an unassigned section-layer, until all data memories for all cores have been assigned a section or have been intentionally left vacant. Sections can be left vacant if the AI-CP determines it would be advantageous to finish processing a section before starting a new batch of section-layers. Once the AI-CP has finished assigning all section-layers for the current slice, the AI-CP will proceed to the next slice and repeat the process until all section-layers of the user's AI model have been assigned. Alternate embodiments can assign or label sections in different orders. Additionally, alternate embodiments can assign sections to data memories in different orders. Still other alternate embodiments can assign multiple section-layers to a single data memory.

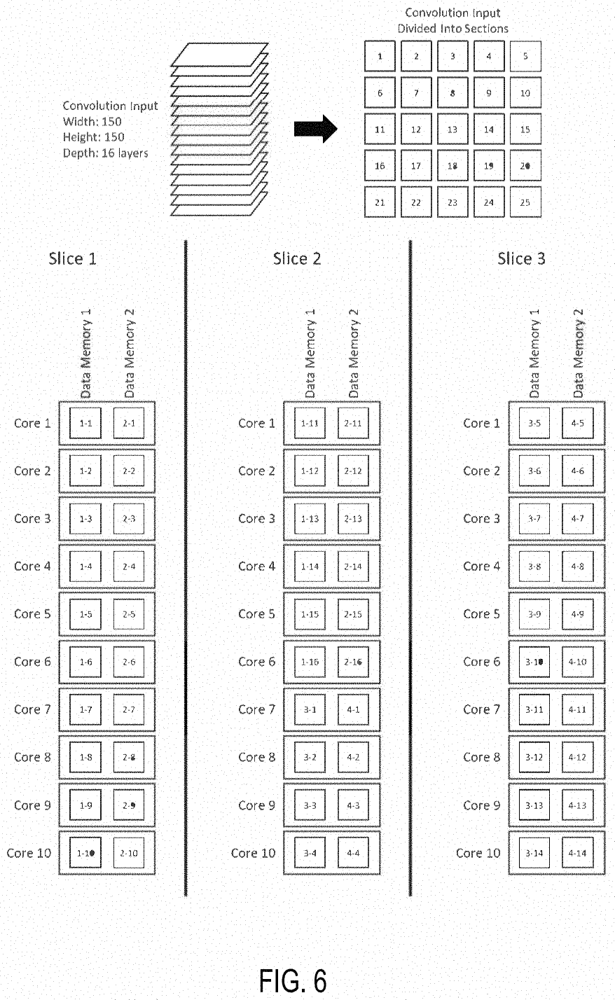

An example of the assigned section-layers is presented in accompanying FIG. 6. In FIG. 6, the convolution input is divided into sections: five sections left to right and five sections top to bottom, for a total of 25 sections. For the example, each data memory in each core is assigned a section-layer which is denoted using the notation #1-#2 where #1 is the section number and #2 is the layer number.

Once the sections have been assigned to the data memories, the AI-CP then assigns filters to cores. The AI-CP will only assign the layers of a filter that align with the layers of the convolution input assigned to a core. Each core will be assigned the corresponding filter layers for all filters for each slice. The AI-CP determines the number of filters (f) that each core can process simultaneously. Then, the AI-CP divides the filters into filter batches such that each slice contains one or more filter batches and the set of filter batches contained within a slice contains all filters for the layer group. Once this is completed, the schedule has divided the convolution input for each layer group into sections, all sections have been assigned to a slice, within the slice each core is assigned sections, within each slice all filters have been assigned to filter batches, and filter layers have been assigned to cores.

In addition to the above, if the user's AI model contains depth-wise convolutions, the AI-CP adds the following to the schedule: combining the separable and non-separable convolutions into a single slice to be processed together. Additionally, for each convolution operation, the AI-CP marks on the schedule whether the convolution being performed is a separable convolution on non-separable. This informs the generated core on what inputs to select to the multipliers and adders when processing the convolutions.

Creating the schedule in the given fashion optimizes the reading from and writing to external memory. This approach enables each section of the convolution input to be read from external memory only once. Furthermore, this allows for the results of multiple convolution operations from different filter layers within the same filter to be combined internally before being written to external memory. This minimizes the amount of data that must be written to external memory and later read back into the generated chip design. Reducing the amount of data read from and written to external memory significantly improves overall computational throughput, power consumption, and allows the generated chip to achieve higher AI inferences per second.

Next the AI-CP creates a schedule for the NN operations. Given a layer within the NN portion of the CNN, the AI-CP determines its schedule considering the layer's input nodes and output nodes. First, the AI-CP determines how many output nodes each core can process simultaneously (o). Then, the AI-CP determines whether to process all output nodes simultaneously or in batches. If all are processed simultaneously, instead of in batches, NN processing will likely use more cores. Additionally, if there are more output nodes than the generated chip can process simultaneously, the AI-CP will process the NN computations in batches and will decide the batch size. Once the AI-CP determines o and how many batches will be required, the AI-CP begins to assign output nodes to cores. The AI-CP will assign the output nodes in a round robin fashion until a batch is filled and will continue the round robin assignment with the next batch. The AI-CP schedules all NN layers following the previous procedure. Alternate embodiments may include one or more components of the schedule and it is contemplated that each individual component of schedule creation may not require every step of the schedule creation process. Alternate embodiments can create the schedule manually.

Once the CNN and NN computations are scheduled, the AI-CP schedules the reads and writes to external memory. For the following discussion on reading and writing to external memory, reading from external memory is referred to as a read and writing to external memory is referred to as a write. First, the AI-CP schedule reads for each slice of CNN processing. The AI-CP first schedules reads for the first data memory of each core. To schedule a read, the AI-CP sets the time that the read should occur, the start address of the read and the number of addresses to read. After scheduling reads for the first data memory of each core, the AI-CP schedules when the cores should begin their first convolution operations of the slice. The AI-CP schedules each core to begin the convolution operation once each core that has the same section identifier has finished reading in data from external memory. If all cores are assigned the same section identifier, then all cores will be scheduled to start the convolution operations at the same time. If cores are assigned different section identifiers, then the AI-CP will schedule multiple convolution starts. To schedule the start of a convolution operation, the AI-CP records the time at which convolution processing should begin. An alternate embodiment can receive a ready signal from each core and then begin the convolution operation once the appropriate cores are ready. The AI-CP then schedules the reads for the remaining data memories for the slice. The read in for data memories other than the first data memory can overlap with convolution processing due to the multiple buffering design of the generated cores.

To determine the timing of reads, the AI-CP determines for each data memory how long the read will take. For each section being read in, the AI-CP determines the number of reads required based on the section width and section height, as well as the external memory read bus width. Furthermore, the AI-CP accounts for the type of memory interface and determines the total read time. The AI-CP then determines the read time for all reads in a slice and then sets the timing of future reads in accordance with the amount of time required for reading in data.

The AI-CP then assigns timing information for each filter assignment. The first filter batch is assigned to be distributed at the beginning of the slice. If this requires reading data from external memory, the read can be scheduled prior to reading in the section data for data memories. After the first filter batch, the AI-CP determines the amount of time needed for the filter batch's convolution operations. This is dependent on the filter size, the section width, and the section height. From this, the second filter batch is scheduled to be read from external memory and distributed before the first filter batch finishes computing. This process and timing decision are continued for each filter batch in the slice.

Next, the AI-CP schedules writes for each filter batch. Once a filter batch has finished processing its convolution operations, the AI-CP schedules for the filter batch to be written to external memory. The AI-CP first determines how many computed sections will need to be written to external memory. This depends on the number of unique section identifiers assigned to cores and the number of filters that can be processed simultaneously. From this the AI-CP determines the time that each computed filter section will be written to external memory. Next, the AI-CP must determine the address start of each write. The AI-CP tracks which memory sections will be required to be reused for future calculations and cannot yet be overwritten. This includes values that will be combined in the DOC or values that will be used for computing skip layers or concatenation layers. For each filter computation to write to external memory, the AI-CP determines if it will be required for later processing and what is the first available address that can fit the data to be written without overwriting data that needs to be retained. From this, the AI-CP determines the address start for the computed data. The AI-CP then assigns write timings, address starts and address counts for each write within the filter batch. The AI-CP then repeats this process to schedule writes for each filter batch within a slice.

After scheduling the writes for each filter batch, other than filter layers that are the first layers of the filter to be processed, the AI-CP schedules reads for previously computed convolutions. For filters whose layer count exceeds the number of cores or data memories and cannot be contained within the generated chip, the generated chip will read data into the DOC to be combined with the current filter convolutions. The AI-CP schedules the reads for the DOC such that they can occur after reading in data for the first data memory of each core, but before the end of the filter batches' convolution operations. The AI-CP then schedules DOC reads for each appropriate filter batch in a slice. As a read, the scheduled DOC read contains a read time, address start, and an address count. The AI-CP determines the address start from the location that was previously written to when scheduling the writes. For such reads as the DOC reads that have a range of possible times at which the read can begin, the AI-CP records the range and later sets the specific timing. Additionally, the AI-CP schedules reading and sending bias values to the DOC.

After the AI-CP schedules the DOC reads, the AI-CP schedules the reads for skip layer data. The AI-CP follows the same process to determine the timing and memory locations of the data to be read in for the SCs reads as the DOC reads. However, the data to be read in for the SCs must be done such that the SC data is available once the corresponding computations for a filter for a section have been completed for all filter layers. Additionally, not all layers or layer groups will contain skip connections.

Finally, the AI-CP schedules when to read in batch normalization data. For each filter performing convolutions, the batch normalization data must be read into the generated chip such that the batch normalization data is present once all layers for a filter for a section have been computed. This allows for a wide range of possible times to read in the batch normalization data. The AI-CP records the possible range of times from the end of reading in the data memory to the final filter layer computations for each filter as the time range for when batch normalization data can be read in. The AI-CP then schedules the time range, the address start for the stored batch normalization data and address count for the batch normalization reads.

Once the AI-CP has scheduled the read, write, and computations for all filter batches within the first slice, the AI-CP proceeds to schedule the reads, writes, and computations for the remaining slices. For slices other than the first, the AI-CP schedules reading in data for the first data memories while the previous slice is performing convolution operations due to the multiple buffering design of the generated cores. This is not the case for cores with a single data memory. The AI-CP schedules data to be read in for the first data memory of all slices after the first in such a manner that the data is ready to be processed once the previous slice finishes its convolutions. The AI-CP then schedules all other reads, writes, and convolutions in the same way as previously described. This process is repeated for each slice of each layer within the user's AI model. After this, the AI-CP will have scheduled the layer group data reads and layer group data writes for all sections of all layers.

Next, the AI-CP schedules when to apply the functionality of the AF, BN, P, and SC. Each of these modules, and potentially multiple of each, shall be applied only after all filter layers for a filter have been convolved with each corresponding layer of a section. First, the AI-CP determines which of the BN, P, and SC will be used for the current layer group, if any. The AI-CP then schedules which of these modules to be active. In some embodiments this will result in the generated chip selecting the appropriate input within each instantiated BN, P, and SC module. Next, the AI-CP schedules when the AF and active BN, P, and SC modules will apply their respective calculations. Each instantiated module will have data flow through them, some of which the instantiated modules will apply their calculations, and other times when the instantiated modules will act as a pass through without performing calculations on the data. The instantiated AF, BN, P, and SC modules will only process data from filter batches that contain the last layer of a filter. Additionally, filter batches that contain the last layer of some filters, but not the last layer of other filters, will mark only the filters that contain the last layer of the filter to be processed by the AF, BN, P, and SC. The AI-CP then analyzes the filters sections that will be written out through the DOC and will record how many filter sections are written out by the DOC before applying the calculations of the AF, BN, P, and SC. The AI-CP then schedules the AF, BN, P, and SC instantiated module to be active after nfs sections are written out of the DOC where nfs is the number of convolved filter sections to delay until applying the AF, BN, P, and SC calculations. Additionally, the AI-CP changes the value of nfs after each convolved filter section is written out of the DOC.

Additionally, the AI-CP sets the parameters of the AF, BN, P, and SC per layer group. For the activation function, the AI-CP schedules the correct activation function for each layer group. If the layer group contains multiple activation functions, the AI-CP schedules the correct activation function for when a filter section is written out of the DOC. The AI-CP schedules the correct activation functions for processed NN layers in the same manner. In some embodiments, the instantiated AF modules contain the different activation functions that can be applied. The generated chip executes the scheduled activation function through multiplexers to select the correct activation function logic. The BN and SC functionality is scheduled as discussed previously by setting the address start and address count to read from external memory and load the parameters into the respective instantiated modules. Finally, the AI-CP schedules the parameters to be set for the instantiated P modules such that the correct type of pooling is selected and the correct pooling dimensions are set. The AI-CP schedules all of these values to be set per layer group before the last layer of the respective filter sections completing their convolution operations or before the first output node of a NN layer completing its computations.

For each layer group, the AI-CP also schedules the values of deconvolution and upsampling. For each of these, the AI-CP schedules the time at which these values will be set for each layer group. The AI-CP must schedule these values to be set prior to reading in any data to be stored in data memories.

Finally, if multiple external memories are used, the AI-CP sets the direction of all memories per layer group and schedules switching between external memories.

Once the scheduling tasks are complete, the AI-CP analyzes all time ranges within the schedule that have not been given a specific time and determines the time for each operation.

Some embodiments implement the schedule through commands that set registers and global registers to contain specific values, commands that select which input connections or interfaces to use for different modules, or commands that begin certain operations. With this structure, some embodiments in addition to the above schedule creation, the AI-CP adds to the schedule sleep times in which no reads, writes, setting registers, or beginning operations occur. The AI-CP goes through the schedule and fills in time where no reads, writes, settings registers, or beginning operations occur and adds sleep commands to count until it is time to perform the next read, write, setting of a register, or beginning of an operation. The sleep commands added to the schedule will set registers within the MC so that counters continue to track the amount of time slept. Once the counters reach the sleep value, the sleep is halted and the next operation is performed. Alternate embodiments may not schedule sleep times, but instead rely on other techniques such as a global operations counter. Alternate embodiments can generate logic that selects the correct scheduled values based on either time, the current layer group being processed or the current state of the computation.

Alternate embodiments can create schedules following various methods. One alternate embodiment can assign sections to cores such that each core processes all layers of the section. Another alternate embodiment can schedule sections to be completely computed by a core along with all filters being processed by the core, such that the generated chip does not need the DOC. Alternate embodiments can also assign multiple layers of a section to data memories and can or cannot need the DOC. Another alternative can intentionally assign a greater number of sections to be processed simultaneously.

Alternate embodiments can also create a schedule for chip designs or resource allocations that are statically defined. Some embodiments create a schedule for the determined resource allocation. However, an alternate embodiment includes creating a schedule for a chip design with a known design or known resource allocation.

### MAC Reduction

In addition to the previous core structure, and according to the present disclosure, a technique has been developed that is referred to herein as “MAC Reduction” and which can increase computational throughput and/or reduce power consumption. MAC Reduction first evaluates all multiplication values of an assigned filter and stores the results in a lookup table. When performing convolutions, the pre-multiplied values are recalled from the lookup table. This is instead of, or in addition to, the AI-CP's previously stated implementation that utilizes DSP slices to perform multiplications. In contrast, MAC Reduction utilizes a portion of memory as the lookup table to perform multiplication and an adder to perform the accumulation. After a filter is assigned, the possible multiplication values of the filter are pre-computed and stored in a memory unit. To pre-compute the multiplication lookup table, for each UoT a summation is incremented by the filter value and stored in the next memory address.

To implement MAC Reduction, the AI-CP generates a filter variable, a summation variable, and logic to implement calculating the running summation of the multiplication values, storing the multiplication values, and retrieving the multiplication values. The AI-CP utilizes the memory units previously allocated to the MAC memories. The AI-CP then generates logic such that once a filter value is assigned, the filter variable is set to the filter value and the summation variable is reset, most commonly to the filter value received. In some embodiments, the summation variable is reset to the filter value and the first memory address is reset to 1, leaving the stored value of memory address zero to be zero. Then, the AI-CP generates logic to increment the summation by the filter value after each UoT until the summation reaches a certain maximum or a number of UoTs have passed. The AI-CP then generates logic to store the summation in successive memory locations after each UoT while the lookup table is being computed. After this, the AI-CP generates logic to read from the memory during convolution operations. During the convolution operation, a data memory will read out a value from the stored input data. The AI-CP generates logic to take the data memory's stored input data and read out the corresponding address from a lookup table within a MAC memory which is therefore the data memory's stored input data times the assigned filter value. The AI-CP then generates logic to send the value read from the MAC memory to the DOC where the values for different filter layers are combined.

Additionally, MAC Reduction can implement multiple filters within a single memory unit. The AI-CP determines how many filters a single memory unit can support. Then, the AI-CP generates filter variables, summation variables, and logic to implement calculating the multiplication values using running summations, storing the multiplication values, and retrieving the multiplication values from a MAC memory for each filter the MAC memory will simultaneously support. The AI-CP also alters the logic generated within the DOC to support combing data for multiple filters such that the DOC can support the maximum number of simultaneously supported filters.

Alternate embodiments can use memory units that are not located within a core for MAC Reduction. Instead, alternate embodiments can use memory units anywhere in the chip such that they follow the design of MAC Reduction.

### Alternative Aspects and Embodiments

In at least one embodiment, the presently disclosed technology takes the form of a method for designing one or more computer logic components. The method comprises (includes, but is not necessarily limited to) instantiating an accelerated design environment (“ADE”). A chip design format is chosen. Then receiving a set of chip design code compatible with the chosen chip design format. Next, extracting a code structure and one or more user-defined attributes from the chip design code. Finally executing a set of chip design algorithms to generate at least one chip design component of the one or more computer logic components, wherein the at least one chip design component implements the one or more user-defined attributes.

The method further includes choosing a chip design format comprising receiving an indication from one or more users of the ADE of a preferred chip design format.

The chosen chip design format comprises a hardware description language (“HDL”).

The chip design algorithms comprise pre-selected, user-defined algorithms.

The generated chip design comprises HDL code.

At least one of the one or more logic components comprises a component related to an artificial-intelligence-to-chip platform (“AI-CP”).

The AI-CP implements at least one of a convolutional neural network (“CNN”) and a neural network (“NN”).

The AI-CP implements deep learning chip generation by (a) determining core resources and core count by analyzing the user-defined attributes and resources available; (b) generating a plurality of HDL modules having attributes corresponding to the determined core resources and core count; and (c) instantiating each of the generated HDL modules.

The AI-CP instantiates and executes a computation and memory management schedule.

The one or more logic components comprises a multiple buffering deep learning core.

In an alternative embodiment, the present technology comprises a computing device having one or more processors, at least one memory device that stores executable computer program logic for execution by the one or more processors and an executable computer program logic.

The computer program instantiates an accelerated design environment (“ADE”) including: (a) choosing a chip design format; (b) receiving a set of chip design code compatible with the chosen chip design format; (c) extracting a code structure and one or more user-defined attributes from the chip; (d) design code; and (e) executing a set of chip design algorithms to generate at least one chip design of the one or more computer logic components, wherein the at least one chip design implements the one or more user-defined attributes.

Further, the program chooses a chip design format that includes receiving an indication from one or more users of the ADE of a preferred chip design format.

The chosen chip design format comprises an HDL.

The chip design algorithms comprise pre-selected, user-defined algorithms.

The generated chip design comprises HDL code.

The logic components comprise a component related to an artificial-intelligence-to-chip platform (“AI-CP”).

The AI-CP implements at least one of a convolutional neural network (“CNN”) and a neural network (“NN”).

The AI-CP implements deep learning chip generation by: (a) determining core resources and core count by analyzing the user-defined attributes and resources available; (b) generating a plurality of HDL modules having attributes corresponding to the determined core resources and core count; and (c) instantiating each of the generated HDL modules.

The AI-CP instantiates and executes a computation and memory management schedule.

The logic component(s) comprises a multiple buffering deep learning core.

In yet another embodiment, the presently disclosed technology comprises: instantiating memory units and/or registers and logic that precomputes the multiplications of a given value and performs multiplications by recalling those values. This embodiment further comprises precomputing the multiplications for a given filter value for deep learning calculations.

In still other embodiments, the present technology includes matching a user specified string to a user specified algorithm, which is the core of the Accelerated Development Environment. The Schedule Creation determines at each unit of time what values should be computed/computation blocks be started. Multiple buffering cores are contemplated. Two import aspects are that it performs deep learning calculations and stores future data before the computations for that data begins.

Another aspect is a unique AI generated chip architecture. Importantly, the architecture computes and combines the result for a specific pixel in an output channel at the same time. Further, it is self-sufficient and does not require communication with a processor.

Yet another aspect is the capability to generate a chip that can instantiate and connect various components depending on the number of resources provided.

Auto Routing is another unique aspect. In this regard, a user can specify a signal, where it came from and/or where the signal is going. Further, the design is modified such that the signal is available in both locations.

In another aspect, given a set of code, the process identifies a user specified set of one or more characters and runs a user specified algorithm. Furthermore, the algorithm modifies the set of code. Still further, the algorithm stores zero or more values that can be used by zero or more of the following attributes.

Yet another aspect is the capability of one of more attributes comprising schedule creation that determines at each unit of time what values should be computed/computation blocks be started. Regarding scheduling, one or more machine learning models are utilized for the chip design that contains zero or more memory units and zero or more computing units. A schedule is returned of operations that require one or more values to compute the machine learning model inference.

The schedule also specifies which computation groups start at which units of time.

The schedule also includes memory read and write operations that are external to the chip design.

Future memory values are read into the chip design before the values are needed for processing.

The operation schedule can be paused and resumed.

The chip design only requires a single start signal, but can accommodate multiple start signals, to begin executing the created schedule. The start signal can be inferred from format of the input data, or the input data itself.

The schedule can be store in an electronic memory and executed without the use of a processor component.

The schedule can set zero or more registers within the chip design.

Concerning memory units, one or more compute units are included with a set of chip design components that includes: (a) a set of chip design components that store current and future data values in the memories; (b) a set of one or more registers that store current and future filter values; (c) a set of chip design components that connect memory output and filter values to compute units; and (d) a set of chip design components that read from memory in a manner suitable to deep learning operations. In some embodiments, the data remains with one compute unit. In other embodiments, the data is moved from one compute unit to the next compute unit.

Regarding the disclosed AI chip generation architecture, a chip is generated pursuant to the method in which a user specifies a machine learning model and the amount of chip design resources that the method can allocate. The method then determines how to arrange the chip design resources to create a chip design that implement the inference of the machine learning model and outputs chip design components that implement the determined chip design.

In these regards: (a) the specified resources comprise one or more compute units; (b) the specified resources comprise one or more memory units; (c) the output chip design is a component to be included in another chip design in some instances, but in other instances, the output chip design is not incorporated into other chip designs; (d) the method is also given an operation schedule and the method arranges the chip design resources such that the chip design components implement that operation schedule; (e) the method uses zero or more predesigned chip components in addition to the chip components that are generated; (f) the method determines how many resources will be assigned per compute core and instantiates multiple compute cores; (g) the output chip design components are not required to interact with a computer processing component; (h) the method also determines how to arrange chip design components that implement one or more activation functions included or not included in the machine learning model; (i) the method also determines how to arrange chip design components that implement machine learning pooling operations; (j) the method also determines how to arrange chip design components that implement machine learning batch normalization operations; (k) the method also determines how to arrange chip design components that coordinate operations between one or more compute cores; (l) the method also determines how to arrange chip design components that read and write external values; (m) the method also determines how to arrange chip design components to connect one or more signals from a source to a destination; and (n) the method also determines how to arrange chip design components such that compute cores use the structure described herein.

Another unique aspect is auto routing that comprises a method incorporating a set of chip design components. The user specifies one or more signals within a component and the source or destination of one or more signals. The method modifies the chip description such that the one or more signals from the source is connected to one or more signals in the destination. Further, the user specifies one or more sources for one or more signals. The method connects one or more signals from one or more sources to one or more signals in the destination. The user specifies one or more sources and one or more destinations for one or more signals and the method connects one or more signals from the one or more sources to one or more signals in the one or more destinations. Further, the user can specify the same or different names for the signals in the source and destination.

Concerning the developed MAC Reduction, one or more memory units are included with one or more compute units. There are one or more desired functions and one or more units of time. The one or more compute units compute the one or more desired functions for a desired range of inputs to the one or more functions. The results from the one or more functions are stored in the one or more memory components. When the results of the one or more functions are needed, the results are read from the one or more memory components.

What is claimed:

1. A method for generating a chip design:
implementing, in a chip design, a neural network;
incorporating deep learning and artificial intelligence models having a framework adaptable to use a wide variety of machine leaning, deep learning, and AI models, and
utilizing other mathematical operations to compile time.
